(19) United States
(12) Patent Application Publication
(10) Pub. No.: US 2025/0032918 A1
(43) Pub. Date: Jan. 30, 2025

(54) INTERACTION IN VIRTUAL SCENE

(71) Applicant: Tencent Technology (Shenzhen) Company Limited, Shenzhen (CN)

(72) Inventors: Teng CHEN, Shenzhen (CN); Siyuan WANG, Shenzhen (CN); Qien DONG, Shenzhen (CN); Guanjun ZHANG, Shenzhen (CN); Liming KONG, Shenzhen (CN)

(73) Assignee: Tencent Technology (Shenzhen) Company Limited, Shenzhen, GD (CN)

(21) Appl. No.: 18/914,012

(22) Filed: Oct. 11, 2024

Related U.S. Application Data
(63) Continuation of application No. PCT/CN2023/108282, filed on Jul. 20, 2023.

(30) Foreign Application Priority Data
Aug. 23, 2022 (CN) 202211014327.5

(51) Int. Cl. A63F 13/52; A63F 13/55; A63F 13/60; A63F 13/87; G06T 13/40; G06T 17/00

(52) U.S. Cl. CPC A63F 13/52; A63F 13/55; A63F 13/60; A63F 13/87; G06T 13/40; G06T 17/00

(57) ABSTRACT

In a method for displaying virtual characters in a virtual scene, the virtual scene is displayed in a first application on a first terminal. A first account corresponding to a first virtual character is logged into the first application. An interaction control element is displayed in the virtual scene. The interaction control element indicates interaction information between the first account and a second account in an interaction scene outside the virtual scene. In response to detecting a user operation on the interaction control element, a second virtual character corresponding to the second account is added to the virtual scene. Apparatus and non-transitory computer-readable storage medium counterpart embodiments are also contemplated.

### RELATED APPLICATIONS

The present application is a continuation of International Application No. PCT/CN2023/108282, filed on Jul. 20, 2023, which claims priority to Chinese Patent Application No. 202211014327.5, filed on Aug. 23, 2022. The entire disclosures of the prior applications are hereby incorporated by reference.

### FIELD OF THE TECHNOLOGY

This application relates to the field of virtual scenes, including interaction in a virtual scene.

### BACKGROUND OF THE DISCLOSURE

In an application that provides a virtual social function, a scene in which a user socializes in a virtual picture through a virtual character or a virtual image exists, which may also be understood as a virtual social scene.

In the related art, when a user A receives a message transmitted by a user B, and a virtual character corresponding to the user B is not located in a virtual picture, the user A needs to manually search a contact list for the user B through another entrance to complete an addition operation if the user A wants to add the virtual character of the user B to the virtual picture.

However, the foregoing manner of adding the virtual character to the virtual picture is very cumbersome, resulting in relatively low human-computer interaction efficiency.

### SUMMARY

This disclosure provides a method, apparatus, and a non-transitory computer-readable storage medium for interaction in a virtual scene, so that a virtual character in a virtual scene may be added more simply and more conveniently, thereby improving human-computer interaction efficiency. Examples of technical solutions in the embodiments of this disclosure may be implemented as follows:

An aspect of this disclosure provides a method for displaying virtual characters in a virtual scene. The virtual scene is displayed in a first application on a first terminal. A first account corresponding to a first virtual character is logged into the first application. An interaction control element is displayed in the virtual scene. The interaction control element indicates interaction information between the first account and a second account in an interaction scene outside the virtual scene. In response to detecting a user operation on the interaction control element, a second virtual character corresponding to the second account is added to the virtual scene.

An aspect of this disclosure provides an apparatus for displaying virtual characters in a virtual scene. The apparatus includes processing circuitry configured to display the virtual scene in a first application on a first terminal. A first account corresponding to a first virtual character is logged into the first application. The processing circuitry is configured to display an interaction control element in the virtual scene. The interaction control element indicates interaction information between the first account and a second account in an interaction scene outside the virtual scene. In response to detection of a user operation on the interaction control element, the processing circuitry is configured to add a second virtual character corresponding to the second account to the virtual scene.

An aspect of this disclosure provides a non-transitory computer-readable storage medium storing instructions which when executed by a processor cause the processor to perform any of the methods of this disclosure.

Technical solutions provided in the embodiments of this disclosure can have the following beneficial effects.

The second virtual character is added to the virtual scene through the operation performed on the interaction control displayed in the virtual scene. On the one hand, compared with the manner in the related art in which another virtual character needs to be added to the virtual scene picture through another entrance after the chat interface is closed, the method provided in the embodiments is simple and convenient to operate, and an operation of adding a virtual character outside the scene to the virtual scene by a player is more coherent, thereby improving the human-computer interaction efficiency. In addition, a waste of computer display resources caused by a fact that the player needs to enable another entrance to add the virtual character is avoided. On the other hand, the player may continue the interaction with another player in the interaction scene outside the virtual scene in the virtual scene, without the need to switch the virtual scene to another interaction scene to interact with the another player, thereby improving efficiency of interaction between players.

### BRIEF DESCRIPTION OF THE DRAWINGS

FIG. 1 is a schematic diagram of a method for interaction in a virtual scene in the related art.

FIG. 2 is a structural block diagram of a computer system according to an embodiment of this disclosure.

FIG. 3 is a schematic flowchart of a method for interaction in a virtual scene according to an embodiment of this disclosure.

FIG. 4 is a schematic flowchart of a method for interaction in a virtual scene according to an embodiment of this disclosure.

FIG. 5 is a schematic diagram of a method for interaction in a virtual scene according to an embodiment of this disclosure.

FIG. 6 is a schematic diagram of a method for interaction in a virtual scene according to an embodiment of this disclosure.

FIG. 7 is a schematic diagram of a method for interaction in a virtual scene according to an embodiment of this disclosure.

FIG. 8 is a schematic flowchart of a method for interaction in a virtual scene according to an embodiment of this disclosure.

FIG. 9 is a schematic diagram of a method for interaction in a virtual scene according to an embodiment of this disclosure.

FIG. 10 is a schematic diagram of a method for interaction in a virtual scene according to an embodiment of this disclosure.

FIG. 11 is a schematic diagram of a method for interaction in a virtual scene according to an embodiment of this disclosure.

FIG. 12 is a schematic flowchart of a method for interaction in a virtual scene according to an embodiment of this disclosure.

FIG. 13 is a schematic diagram of a method for interaction in a virtual scene according to an embodiment of this disclosure.

FIG. 14 is a schematic diagram of a method for interaction in a virtual scene according to an embodiment of this disclosure.

FIG. 15 is a schematic diagram of an operation process of a method for interaction in a virtual scene according to an embodiment of this disclosure.

FIG. 16 is a schematic timing diagram of a method for interaction in a virtual scene according to an embodiment of this disclosure.

FIG. 17 is a schematic timing diagram of a method for interaction in a virtual scene according to an embodiment of this disclosure.

FIG. 18 is a schematic structural diagram of an apparatus for interaction in a virtual scene according to an embodiment of this disclosure.

FIG. 19 is a structural block diagram of a terminal according to an embodiment of this disclosure.

### DESCRIPTION OF EMBODIMENTS

First, examples of terms involved in embodiments of this disclosure are briefly described. The descriptions of the terms are provided as examples only and are not intended to limit the scope of the disclosure.

Virtual social interaction: A player customizes a 2D or 3D humanoid model thereof through a Do It Yourself (DIY) process, to generate a virtual character, and uses the virtual character of the player to socialize with another virtual character, such as chatting. Such a virtual social behavior similar to a social behavior in a real world is generated in a virtual world.

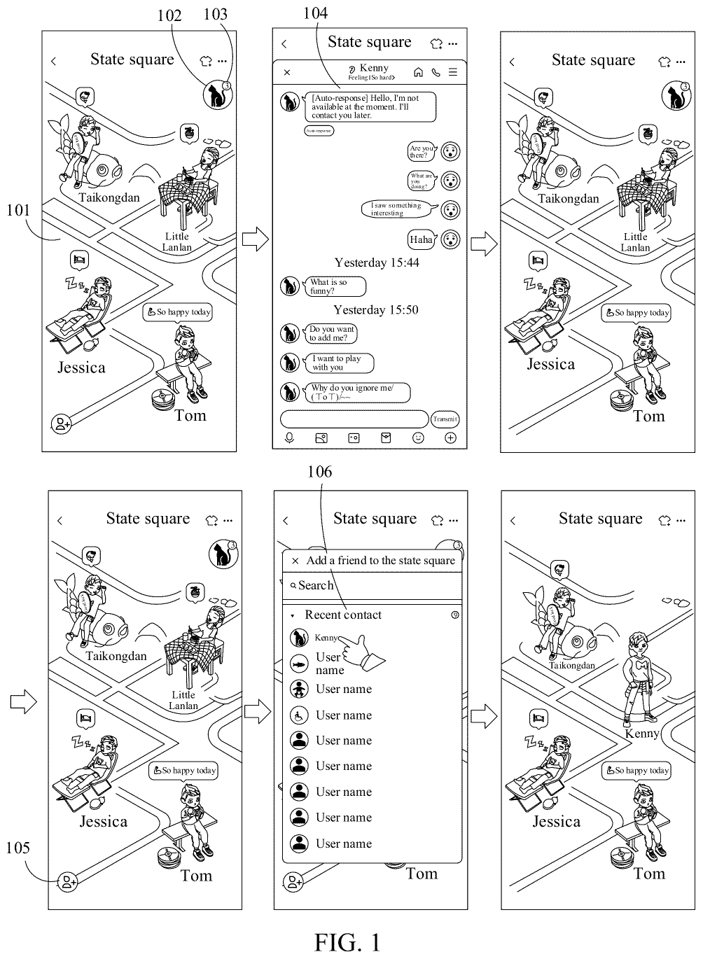

Addition of a virtual character: FIG. 1 is a virtual scene 101 corresponding to a player A. When a player B associated with a virtual character outside the virtual scene 101 transmits a message, a message prompt is displayed on a screen in a manner. For example, a message bubble 102 including an avatar of the player B and a quantity 103 of unread messages are displayed to inform the player A that the unread messages currently exist. After the player A clicks/taps the unread messages, a chat detail page 104 pops up to display specific message content.

When the player A closes the chat detail page, there is no further guidance operation. The operation process of the player A is interrupted. In this case, if the player A wants to add a virtual character associated with the player B who has just finished chatting to the virtual scene 101, the player needs to search for another entrance. For example, the player A clicks/taps to open a contact list 106 at a contact entrance 105, manually searches the contact list 106 for a corresponding contact, and then manually performs an adding operation.

However, the foregoing solution of adding the virtual character is cumbersome and complicated, and human-computer interaction efficiency is relatively low. In addition, experience of the player during the operation is fragmented. After the player finishes chatting, the player has a requirement for adding, to a scene, a player and a virtual character in which the player is interested. However, the adding process ends after the chat is ended, and the player can only find an entrance to add a friend again and initiate a new operation process. Due to lack of a smooth and simple experience, the player has a relatively high failure rate in the process of adding a friend.

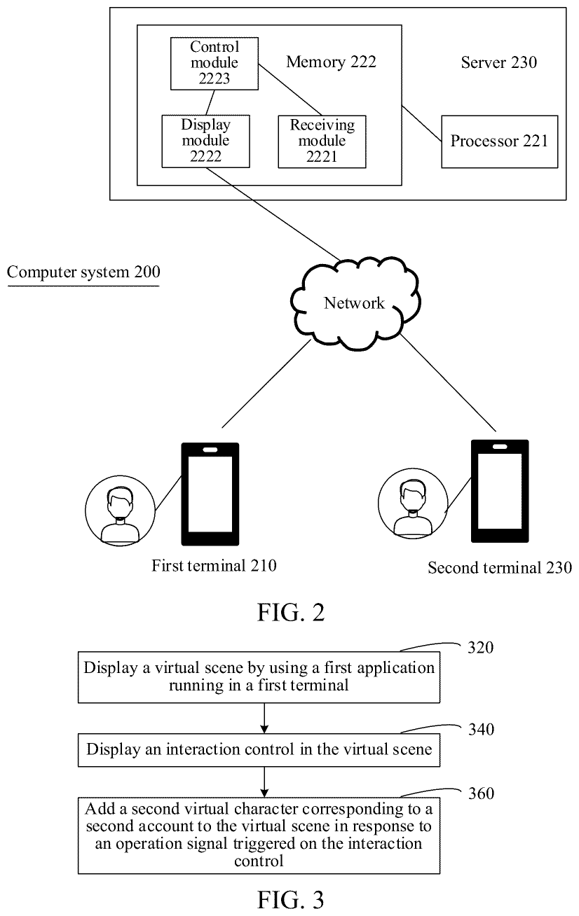

FIG. 2 is a structural block diagram of a computer system according to an embodiment of this disclosure. A computer system 200 includes a first terminal 210, a server 220, and a second terminal 230.

The first terminal 210 has an application supporting display of a virtual character installed and running therein, for example, an instant chat program, a voice chat program, a social program, a virtual social program, or a metaverse program. A first account is logged in to the application installed in the first terminal 210. The first account is associated with a first virtual character.

In some embodiments, the first account may be considered as a user that uses the first account.

The first terminal 210 is connected to the server 220 through a wireless network or a wired network.

The server 220 includes one of one server, a plurality of servers, a cloud computing platform, and a virtualization center. For example, the server 220 includes a processor 221 (e.g., processing circuitry) and a memory 222 (e.g., a non-transitory computer-readable storage medium). The memory 222 further includes a receiving module 2221, a display module 2222, and a control module 2223. The server 220 is configured to provide a background service for the application supporting the display of the virtual character. In some embodiments, the server 220 is in charge of primary computing, and the first terminal 210 and the second terminal 230 are in charge of secondary computing. Alternatively, the server 220 is in charge of secondary computing, and the first terminal 210 and the second terminal 230 are in charge of primary computing. Alternatively, the server 220, the first terminal 210, and the second terminal 230 perform collaborative computing by using a distributed computing architecture.

The second terminal 230 has an application supporting the display of the virtual character installed and running therein. A second account is logged in to the application installed in the second terminal 230. The second account is associated with a second virtual character.

In some embodiments, the second account may be considered as a user that uses the second account.

In some embodiments, the first virtual character and the second virtual character are in or not in the same virtual scene. In some embodiments, the first virtual character and the second virtual character may belong to the same team, the same organization, have a friend relationship, or have a temporary communication permission.

In some embodiments, the application installed on the first terminal 210 is same as the application installed on the second terminal 230, or the applications installed on the two terminals are the same type of applications on different control system platforms. The first terminal 210 may refer to one of a plurality of terminals, and the second terminal 230 may refer to one of a plurality of terminals. In this embodiment, only the first terminal 210 and the second terminal 230 are used as an example for description. The first terminal 210 and the second terminal 230 are of the same device type or different device types. The device type includes but is not limited to at least one of a smartphone, a tablet computer, an e-book reader, a laptop computer, a desktop computer, a television, an augmented reality (AR) terminal, a virtual reality (VR) terminal, and a mixed reality (MR) terminal. In the following embodiment, an example in which a terminal includes a smartphone is used for description.

A person skilled in the art may know that more or fewer terminals or virtual characters may be provided. For example, only one terminal or virtual character, or dozens or hundreds of terminals or virtual characters, or a larger quantity of terminals or virtual characters may be provided. A quantity of terminals or virtual characters and a device type are not limited in the embodiments of this disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

FIG. 3 is a schematic flowchart of a method for interaction in a virtual scene according to an embodiment of this disclosure. In this embodiment, an example in which the method is performed by the terminal shown in FIG. 2 is used for description. The method includes at least some of the following operations:

Operation 320: Display a virtual scene by using a first application running in a first terminal. For example, the virtual scene is displayed in a first application on a first terminal. In an example, a first account corresponding to a first virtual character is logged into the first application.

A first account corresponding to a first virtual character is logged in to the first application.

In some embodiments, the foregoing virtual scene is a scene displayed when the first application runs on a terminal. The virtual scene may be a simulation environment for the real world or may be a semi-simulation and semi-fiction environment and may also be a purely fictional environment. The virtual scene may be a two-dimensional virtual environment, may be a 2.5-dimensional virtual environment, or may be a three-dimensional virtual environment, which is not limited in this embodiment of this disclosure.

The foregoing virtual scene is configured for the first virtual character to interact with another virtual character.

In some embodiments, interaction between virtual characters includes virtual social interaction, a virtual battle, virtual teaching, a virtual meeting, and the like, which is not limited in this embodiment of this disclosure.

In some embodiments, in a case that the virtual scene is implemented as a virtual battle scene, the first virtual character performs a virtual battle with another virtual character. In a case that the virtual scene is implemented as a virtual teaching scene, the first virtual character performs virtual teaching with another virtual character. In a case that the virtual scene is implemented as a virtual meeting scene, the first virtual character has a virtual meeting with another virtual character. In a case that the virtual scene is implemented as a virtual social scene, the first virtual character performs virtual social interaction with another virtual character. In this embodiment of this disclosure, a virtual social scene is mainly used as an example for description.

A virtual social behavior in the virtual social scene is similar to a social behavior in a real world, including but not limited to at least one of text communication, gesture communication, voice communication, picture communication, a hug, a touch, and a fondle. The first virtual character may be designed, selected, customized, created, user-defined, uploaded to a server, or uploaded to the terminal by the first account (i.e. a user using the first account). The first virtual character is a virtual character in a three-dimensional form.

The first account corresponds to the first virtual character. In some embodiments, the first account is in one-to-one correspondence with the first virtual character, or the first account corresponds to at least two first virtual characters, or the first virtual character corresponds to at least two first accounts.

Operation 340: Display an interaction control in the virtual scene. For example, an interaction control element is displayed in the virtual scene. In an example, the interaction control element indicates interaction information between the first account and a second account in an interaction scene outside the virtual scene.

The interaction control is configured to prompt interaction information of the first account and a second account in an interaction scene outside the virtual scene.

In some embodiments, the foregoing interaction control may be implemented as at least one of a two-dimensional interaction control and a three-dimensional interaction control.

In some embodiments, in a case that the interaction control is implemented as the two-dimensional interaction control, a user interface (UI) includes a scene picture of the virtual scene and a HUD layer (a foreground layer) superimposed on the scene picture. The scene picture is configured to display environmental content in a three-dimensional virtual environment. The HUD layer includes at least one interaction control. The interaction control is visually suspended on an upper layer of the scene picture.

In some embodiments, in a case that the interaction control is implemented as the three-dimensional interaction control, the UI includes some triggerable picture elements included in a scene picture of a three-dimensional virtual scene. Each of the picture elements is a three-dimensional element, i.e., the three-dimensional interaction control.

In some embodiments, in a case that the virtual scene is implemented as a three-dimensional virtual scene, the two-dimensional interaction control is displayed on the three-dimensional virtual scene.

The interaction information between the first account and the second account in the interaction scene outside the virtual scene may be understood as interaction information between a first terminal and a second terminal in the interaction scene outside the virtual scene. The first account is logged in to a virtual scene running on the first terminal, and the second account is logged in to a virtual scene running on the second terminal.

In an example, if an interaction manner of performing interaction in the virtual scene belongs to a first interaction manner, an interaction manner of performing interaction in the interaction scene outside the virtual scene belongs to a second interaction manner. If the second account transmits a message to the first account in the second interaction manner, the message is prompted through the interaction control in the virtual scene, thereby prompting the user corresponding to the first account that the message from the second account exists in the virtual scene.

In some embodiments, the foregoing interaction control is configured to prompt interaction information of the first account and the second account in a social interaction scene outside the virtual scene. The social interaction scene outside the virtual scene includes but is not limited to at least one of the following scenes: social interaction is performed on a text chat interface outside the virtual scene, social interaction is performed on a voice chat interface outside the virtual scene, or social interaction is performed in another virtual scene outside the virtual scene.

In some embodiments, if the foregoing virtual scene is a virtual scene provided by the first application, the interaction scene outside the virtual scene may be an interaction scene provided by a second application. In some embodiments, the first application and the second application may be the same application or may be different applications. Alternatively, in a case that the first application is implemented as a host program, the second application is a mini program installed in the first application. Alternatively, in a case that the second application is implemented as a host program, the first application is a mini program installed in the second application.

In some embodiments, the interaction performed in the interaction scene outside the virtual scene may also be understood as interaction performed on a UI outside the virtual scene. The UI may be superimposed on the virtual scene, floated on the virtual scene, or displayed in a separate window, which is not limited in this embodiment of this disclosure.

In some embodiments, the interaction information includes an instant message transmitted by the second account to the first account in the interaction scene outside the virtual scene. The instant message includes at least one of a text message, a picture message, a video message, an audio message, a card push message, a link message, and the like.

In some embodiments, the instant message transmitted by the second account in the interaction scene outside the virtual scene is automatically displayed through the interaction control. For example, when the second account transmits an instant message of greeting (“Hello, are you there?”) to the first account on a chat interface outside the virtual scene, the interaction control is displayed in the virtual scene corresponding to the first account, and the instant message of “Hello, are you there?” transmitted by the second account is displayed on the interaction control.

Alternatively, prompt information of the instant message transmitted by the second account in the interaction scene outside the virtual scene is automatically displayed through the interaction control. For example, when the second account transmits 2 instant messages to the first account on the chat interface outside the virtual scene, the interaction control is displayed in the virtual scene corresponding to the first account, and a quantity “2” of unread instant messages transmitted by the second account is displayed on the interaction control.

Alternatively, an account identifier corresponding to the second account is automatically displayed through the interaction control. In some embodiments, the account identifier includes at least one of an account name, an account avatar, and the like, which is not limited in this embodiment of this disclosure. For example, when the second account transmits an instant message to the first account on the chat interface outside the virtual scene, the interaction control is displayed in the virtual scene corresponding to the first account, and an account avatar corresponding to the second account is displayed on the interaction control, to prompt the first account that the second account has transmitted the instant message to the first account.

In some other embodiments, the interaction information includes an unread historical message of the first account. The unread historical message includes a message transmitted by the second account to the first account in the interaction scene outside the virtual scene. The historical message includes at least one of a text message, a picture message, a video message, an audio message, a card push message, a link message, and the like.

In some embodiments, the virtual scene is displayed by using the first application running in the first terminal. The interaction control is displayed on the virtual scene in response to the unread historical message transmitted by the second account to the first account in the interaction scene outside the virtual scene.

In an example, after the first virtual character corresponding to the first account enters the virtual scene, if a message transmitted by the second account to the first account currently exists in the interaction scene outside the virtual scene, and the message is an unread message, the interaction control is displayed in the virtual scene.

In some embodiments, the unread historical message of the first account transmitted by the second account in the interaction scene outside the virtual scene is automatically displayed through the interaction control. Alternatively, prompt information of the unread historical message of the first account transmitted by the second account in the interaction scene outside the virtual scene is automatically displayed through the interaction control. Alternatively, the account identifier corresponding to the second account is automatically displayed through the interaction control.

The content displayed on the interaction control is not limited in this embodiment of this disclosure. An example in which the interaction control is implemented as a message prompt control or a chat control is used for description.

In some embodiments, the interaction control includes a message prompt control, the message prompt control being configured to prompt existence of a first message from second account. In some embodiments, display content of the message prompt control includes at least one of a two-dimensional icon, a two-dimensional symbol, a message bubble, a message quantity, message content, message preview, and an account avatar.

In some embodiments, the interaction control includes a chat control. In some embodiments, display content of the chat control includes at least one of an account name, message content, time, and an account avatar.

Operation 360: Add a second virtual character corresponding to a second account to the virtual scene in response to an operation signal triggered on the interaction control. For example, in response to detecting a user operation on the interaction control element, a second virtual character corresponding to the second account is added to the virtual scene.

In some embodiments, the operation signal includes an operation signal corresponding to an interest operation performed on the second account triggered on the interaction control.

The interest operation includes but is not limited to at least one of clicking/tapping the interaction control, double-clicking/tapping the interaction control, sliding the interaction control, dragging the interaction control, touching and holding the interaction control, inputting a character on the interaction control, inputting a voice on the interaction control, viewing the first message from the second account on the interaction control, and transmitting a second message to the second account on the interaction control.

In some embodiments, the second virtual character may be designed, selected, customized, created, user-defined, uploaded to a server, or uploaded to the terminal by the second account (i.e., a user using the second account). The second virtual character is a virtual character in a three-dimensional form.

The second account corresponds to the second virtual character. In some embodiments, the second account is in one-to-one correspondence with the second virtual character, or the second account corresponds to at least two second virtual characters, or the second virtual character corresponds to at least two second accounts.

In an example, an example in which the first application is implemented as an instant messaging application is used for description. The instant messaging application provides two interaction manners: an interaction manner through a chat interface (i.e., an interaction manner of performing interaction in the interaction scene outside the virtual scene), and the other interaction manner of performing interaction in the virtual scene after entering the virtual scene. When a player operates the terminal to enter the virtual scene, a virtual character corresponding to the player is displayed in the virtual scene, and the player may operate the virtual character to interact with another virtual character in the virtual scene.

When the player operates the virtual character in the virtual scene, an interaction control is displayed in the virtual scene if a friend of the player transmits a message to the player through the chat interface, and prompt information of the message is displayed through the interaction control. For example, an avatar of the friend is displayed and an unread message number is displayed on the avatar. The player drags the interaction control to the virtual scene, thereby adding a virtual character corresponding to the friend to the virtual scene. Subsequently, the virtual character is displayed on a terminal interface controlled by the player, and the player may interact with the friend at any time through the virtual character.

In some embodiments, the second virtual character corresponding to the second account is added to the virtual scene in response to the operation signal triggered on the interaction control in a case that the second account logs in to the first application and does not enter the virtual scene.

For example, after the player logs in to the instant messaging application on a player terminal and enters the virtual scene, the first virtual character is displayed in the virtual scene displayed on the player terminal. In this case, a friend of the player logs in to the instant messaging application on a friend terminal and transmits a message to the first account without entering the virtual scene. In this way, an interaction control having an avatar of the second account is displayed in the virtual scene of the player terminal, so as to prompt the existence of the message from the friend of the player to the player. When the player drags the interaction control to the virtual scene on the player terminal, the second virtual character corresponding to the second account is to be added to the three-dimensional virtual scene, and the player may interact with the friend at any time through the virtual character.

In some embodiments, that the second virtual character corresponding to the second account is added to the virtual scene means adding the second virtual character corresponding to the second account to the virtual scene for display, i.e., adding the second virtual character to inside of a virtual scene picture currently displayed by the terminal. The second virtual character is visible to the user.

Alternatively, that the second virtual character corresponding to the second account is added to the virtual scene means adding the second virtual character corresponding to the second account to outside of the virtual scene picture currently displayed by the terminal. The second virtual character is added to the virtual scene, but is invisible to the user. The user may search for the second virtual character by switching the virtual scene picture displayed by the terminal.

In some embodiments, a plurality of second accounts that transmit interaction information to the first account in the interaction scene outside the virtual scene exist.

In some embodiments, a single second account corresponds to a single interaction control.

For example, when a second account a transmits interaction information to the first account in the interaction scene outside the virtual scene, an interaction control 1 corresponding to the second account a is displayed in the virtual scene. When a second account b transmits interaction information to the first account in the interaction scene outside the virtual scene, an interaction control 2 corresponding to the second account b is displayed in the virtual scene.

In some embodiments, a plurality of second accounts correspond to a single interaction control.

In some embodiments, all of the second accounts correspond to a single interaction control.

For example, when there is no account that transmits interaction information to the first account in the interaction scene outside the virtual scene, the interaction control is not displayed in the virtual scene. When the second account a transmits the interaction information to the first account in the interaction scene outside the virtual scene, the interaction control corresponding to the second account a is displayed in the virtual scene, and an account avatar corresponding to the second account a is displayed on the interaction control. When the second account b transmits the interaction information to the first account in the interaction scene outside the virtual scene, the account avatar corresponding to the second account a and an account avatar corresponding to the second account b are simultaneously displayed on the interaction control, or a switching animation of interactive switching between the account avatar corresponding to the second account a and the account avatar corresponding to the second account b is displayed on the interaction control, or the account avatar corresponding to the second account b is displayed on the interaction control.

In some embodiments, second accounts in the same group correspond to a single interaction control.

For example, in a friend list of the first account, the second account a and the second account b belong to a first group, and a second account c belongs to a second group. In this way, when the second account a or the second account b transmits the interaction information to the first account in the interaction scene outside the virtual scene, the account avatar corresponding to the second account a or the second account b is displayed on the interaction control 1. When the second account c transmits interaction information to the first account in the interaction scene outside the virtual scene, an account avatar corresponding to the second account c is displayed on the interaction control 2.

In some embodiments, in a case that a plurality of second accounts correspond to a single interaction control, the interaction control is configured to prompt interaction information of the second account and a plurality of second accounts in the interaction scene outside the virtual scene.

In some embodiments, prompt content corresponding to interaction information respectively corresponding to the plurality of second accounts is simultaneously displayed on the interaction control. The prompt content of the interaction information includes at least one of an interaction message transmitted by the second account in the interaction scene outside the virtual scene, prompt information of the interaction message transmitted by the second account in the interaction scene outside the virtual scene, the account identifier corresponding to the second account, and the like, which is not limited in this embodiment of this disclosure.

In some embodiments, the prompt content respectively corresponding to the plurality of second accounts is simultaneously displayed on the interaction control.

Alternatively, a first switching display animation of the prompt content respectively corresponding to the plurality of second accounts is displayed. The first switching display animation refers to an animation in which the prompt content respectively corresponding to the plurality of second accounts is cyclically displayed based on a sequence in which the second accounts transmit the interaction messages to the first account. Alternatively, prompt content corresponding to a second account that first transmits an interaction message to the first account is displayed on the interaction control. Alternatively, prompt content corresponding to a second account that currently transmits an interaction message to the first account is displayed on the interaction control.

Alternatively, a second switching display animation of the prompt content respectively corresponding to the plurality of second accounts is displayed. The second switching display animation refers to an animation in which the prompt content respectively corresponding to the plurality of second accounts is cyclically displayed based on priorities respectively corresponding to the second accounts (the prompt content corresponding to the second account with a high priority is displayed first, and the prompt content corresponding to the second account with a low priority is displayed last, or the prompt content corresponding to the second account with the low priority is displayed first, and the prompt content corresponding to the second account with the high priority is displayed last). Alternatively, the prompt content corresponding to the second account with the highest priority is displayed on the interaction control.

The priority corresponding to each of the second accounts may be a priority configured by the first account for each second account. Alternatively, the priority is a priority automatically determined based on a frequency of interaction between the first account and the second account. A higher interaction frequency indicates a higher priority. Alternatively, the priority is positively correlated with an account level of the second account. Alternatively, the priority is positively correlated with a quantity of pieces of interaction information transmitted by the second account to the first account. Alternatively, the priority is associated with content of interaction information transmitted by the second account to the first account. A manner of determining the priority of the second account is not limited in the embodiments of this disclosure.

For example, when the priority is associated with the content of the interaction information transmitted by the second account to the first account, a plurality keywords are preset for the first account, for example, “an important notification” and “@”. When the content of the interaction information transmitted by the second account to the first account includes any one of the plurality of keywords, the priority corresponding to the second account is increased, and a magnitude of the increased priority is positively correlated with a quantity of keywords included in the content of the interaction information.

In some embodiments, second virtual characters respectively corresponding to the plurality of second accounts are simultaneously added to the virtual scene in response to the operation signal triggered on the interaction control.

For example, if a plurality of second accounts that transmit instant messages to the first account in the interaction scene outside the virtual scene currently exist, the interaction control is displayed in the virtual scene, and the second virtual characters respectively corresponding to the plurality of second accounts are simultaneously displayed in the virtual scene after the interaction control is dragged to the virtual scene.

According to the method provided in this embodiment of this disclosure, the second virtual characters respectively corresponding to the plurality of second accounts are simultaneously added to the virtual scene, thereby improving efficiency of adding the virtual character to the virtual scene.

In some embodiments, the second virtual characters respectively corresponding to the plurality of second accounts are successively added to the virtual scene in response to the operation signal triggered on the interaction control.

For example, a sequence in which the second virtual characters respectively corresponding to the plurality of second accounts are added to the virtual scene includes at least one of the following cases:

Case I: A sequence in which a plurality of second accounts transmits interaction information to the first account in the interaction scene outside the virtual scene.

For example, at a current moment, if a moment at which the second account a transmits latest interaction information to the first account is prior to a moment at which the second account b transmits latest interaction information to the first account, a second virtual character corresponding to the second account a is displayed first and then a second virtual character corresponding to the second account b is displayed after the interaction control is dragged to the virtual scene.

Alternatively, if a moment at which the second account a transmits first interaction information to the first account is prior to a moment at which the second account b finally transmits first interaction information to the first account, the second virtual character corresponding to the second account a is displayed first and then the second virtual character corresponding to the second account b is displayed after the interaction control is dragged to the virtual scene.

Case II: A sequence of priorities respectively corresponding to a plurality of second accounts.

In some embodiments, the second virtual characters respectively corresponding to the plurality of second accounts are successively added to the virtual scene in descending order of the priorities.

Alternatively, the second virtual characters respectively corresponding to the plurality of second accounts are successively added to the virtual scene in ascending order of the priorities.

The priority corresponding to each of the second accounts may be a priority configured by the first account for each second account. Alternatively, the priority is a priority automatically determined based on a frequency of interaction between the first account and the second account. A higher interaction frequency indicates a higher priority. Alternatively, the priority is positively correlated with an account level of the second account. Alternatively, the priority is positively correlated with a quantity of pieces of interaction information transmitted by the second account to the first account. Alternatively, the priority is associated with content of interaction information transmitted by the second account to the first account. A manner of determining the priority of the second account is not limited in the embodiments of this disclosure.

For example, when the priority is associated with the content of the interaction information transmitted by the second account to the first account, a plurality keywords are preset for the first account, for example, “an important notification” and “@”. When the content of the interaction information transmitted by the second account to the first account includes any one of the plurality of keywords, the priority corresponding to the second account is increased, and a magnitude of the increased priority is positively correlated with a quantity of keywords included in the content of the interaction information.

Case III: An interaction sequence configured by the first account in the interaction scene outside the virtual scene.

For example, the second account a and the second account b that transmit interaction messages to the first account in the interaction scene outside the virtual scene exist, and the first account displays an interaction interface (for example, a chat list) corresponding to the second account b on top in the interaction scene outside the virtual scene. After the interaction control is dragged to the virtual scene, the second virtual character corresponding to the second account b is displayed first, and then the second virtual character corresponding to the second account a is displayed.

The foregoing sequence in which the second virtual character is added to the virtual scene is merely an example, which is not limited in the embodiments of this disclosure.

According to the method provided in this embodiment of this disclosure, the second virtual characters respectively corresponding to the plurality of second accounts are successively added to the virtual scene, so as to prevent a computer from rendering a large number of virtual characters at one time and reduce rendering burden of the computer.

In some embodiments, a selection list is displayed in response to the operation signal triggered on the interaction control. The selection list includes a plurality of second accounts. A selection operation performed on at least one second account of the plurality of second accounts in the selection list is received. A second virtual character corresponding to the at least one second account is added to the virtual scene.

In some embodiments, after the second virtual character corresponding to the second account is added to the virtual scene, the first account may interact with the second account through the virtual character in the virtual scene.

In some embodiments, the second virtual character corresponding to the second account is added to the virtual scene, and an interaction animation corresponding to the second virtual character is displayed. A chat interface corresponding to the first account and the second account is displayed in response to a fourth operation triggered on the interaction animation.

The interaction animation may be implemented as a bubble animation, a balloon animation, a chat box animation, a cloud animation, or the like, which is not limited in the embodiments of this disclosure.

In some embodiments, the foregoing interaction information is displayed on the interaction animation.

For example, when the second virtual character is dragged to the virtual scene, a bubble animation is displayed above the second virtual character, and an instant message transmitted by the second account is displayed on the bubble animation.

In some embodiments, a movement control operation performed on the first virtual character is received, the movement control operation being configured for controlling the first virtual character to move in the virtual scene. The chat interface corresponding to the first account and the second account is displayed when a distance between the first virtual character and the second virtual character is less than or equal to a preset distance.

For example, after the second virtual character corresponding to the second account is added to the virtual scene, the player may control the first virtual character to move toward the second virtual character through the first terminal. When the distance between the first virtual character and the second virtual character in the virtual scene is less than or equal to the preset distance, the chat interface corresponding to the first account and the second account is automatically triggered.

In some embodiments, after the display of the chat interface is triggered, the first account may interact with the second account on the chat interface. A message transmission operation performed on a chat message on the chat interface is received, and the chat message is transmitted to the second account.

The chat message includes at least one of a text message, a picture message, a video message, an audio message, a card push message, a link message, and the like, which is not limited in this embodiment of this disclosure.

In some embodiments, the second virtual character corresponding to the second account is added to the virtual scene, and the interaction animation corresponding to the second virtual character is displayed. The chat message is transmitted to the second account in response to the fourth operation triggered on the interaction animation.

Alternatively, the movement control operation performed on the first virtual character is received, the movement control operation being configured for controlling the first virtual character to move in the virtual scene. The chat message is transmitted to the second account when the distance between the first virtual character and the second virtual character is less than or equal to the preset distance.

In some other embodiments, the first account may directly interact with the second account through the interaction control.

In some embodiments, the chat interface corresponding to the first account and the second account is displayed in response to the operation signal triggered on the interaction control. The message transmission operation performed on the chat message on the chat interface is received, and the chat message is transmitted to the second account.

Based on the above, according to the method provided in this embodiment, the second virtual character is added to the virtual scene through the operation performed on the interaction control displayed in the virtual scene. On the one hand, compared with the manner in the related art in which another virtual character needs to be added to the virtual scene picture through another entrance after the chat interface is closed, the method provided in this embodiment is simple and convenient to operate, and an operation of adding a virtual character outside the scene to the virtual scene by a player is more coherent, thereby improving the human-computer interaction efficiency. In addition, a waste of computer display resources caused by a fact that the player needs to enable another entrance to add the virtual character is avoided. On the other hand, the player may continue the interaction with another player in the interaction scene outside the virtual scene in the virtual scene, without the need to switch the virtual scene to another interaction scene to interact with the another player, thereby improving efficiency of interaction between players.

According to the method provided in this embodiment of this disclosure, the interaction animation corresponding to the second virtual character is displayed while the second virtual character is being added to the virtual scene, so that the first account can interact with the second virtual character in the virtual scene through the interaction animation, thereby improving interactivity of the virtual scene and the human-computer interaction efficiency.

According to the method provided in this embodiment of this disclosure, after the second virtual character is added to the virtual scene, the chat interface between the accounts is automatically triggered if the player controls the first virtual character to move toward the second virtual character, thereby improving the human-computer interaction efficiency of a display process of the chat interface.

According to the method provided in this embodiment of this disclosure, after the chat interface is triggered, the first account can interact with the second account through the chat interface in the virtual scene, thereby improving efficiency of interaction between players.

In some possible embodiments, the foregoing operation 360 includes operation 361.

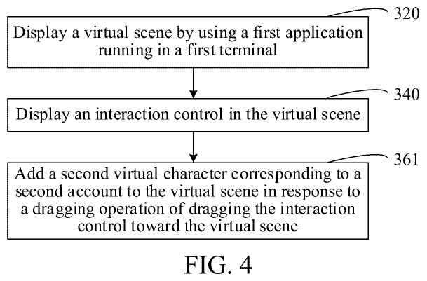

FIG. 4 is a schematic flowchart of a method for interaction in a virtual scene according to an embodiment of this disclosure. In this embodiment, an example in which the method is performed by the terminal shown in FIG. 2 is used for description. The method includes at least some of the following operations:

Operation 320: Display a virtual scene by using a first application running in a first terminal. For example, the virtual scene is displayed in a first application on a first terminal. In an example, a first account corresponding to a first virtual character is logged into the first application.

A first account corresponding to a first virtual character is logged in to the first application.

In some embodiments, the virtual scene may be a two-dimensional virtual environment, may be a 2.5-dimensional virtual environment, or may be a three-dimensional virtual environment, which is not limited in this embodiment of this disclosure.

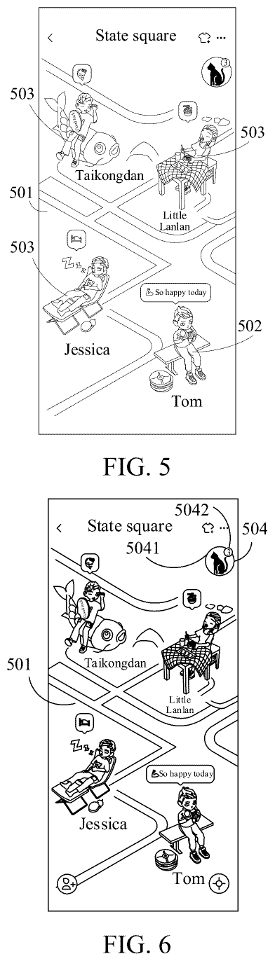

For example, as shown in FIG. 5, a three-dimensional virtual scene 501 corresponding to the first account is displayed. A first virtual character 502 is displayed in the three-dimensional virtual scene 501. The first virtual character 502 performs virtual social interaction with another virtual character 503 in the three-dimensional virtual scene 501.

Operation 340: Display an interaction control in the virtual scene. For example, an interaction control element is displayed in the virtual scene. In an example, the interaction control element indicates interaction information between the first account and a second account in an interaction scene outside the virtual scene.

In some embodiments, the foregoing interaction control may be implemented as at least one of a two-dimensional interaction control and a three-dimensional interaction control.

In some embodiments, in a case that the virtual scene is implemented as a three-dimensional virtual scene, the two-dimensional interaction control is displayed on the three-dimensional virtual scene.

For example, as shown in FIG. 6, an interaction control 504 is displayed in the three-dimensional virtual scene 501. In this embodiment, an example in which the interaction control 504 is a message prompt control is used. The interaction control includes an avatar 5041 of a second account and a message quantity 5042.

Operation 361: Add a second virtual character corresponding to a second account to the virtual scene in response to a dragging operation of dragging the interaction control toward the virtual scene. For an example, the second virtual character is added to the virtual scene in response to detecting the drag operation being performed on the interaction control element toward the virtual scene.

In some embodiments, in response to a dragging operation of dragging the interaction control to any position or a first position in the virtual scene, the second virtual character corresponding to the second account is added to the virtual scene (or added to the virtual scene for display). The first position may be a position where an idle display region exists in the virtual scene. In some embodiments, the idle display region refers to a region in which no another virtual character is displayed. Alternatively, the idle display region refers to a region where no another virtual character and virtual display element (for example, virtual furniture and a virtual seat in the three-dimensional virtual scene) is displayed.

In some embodiments, in response to a dragging operation of dragging the interaction control to a first region in the virtual scene, the second virtual character corresponding to the second account is added to the virtual scene (or added to the virtual scene for display). In some embodiments, the first region is visible in the virtual scene. To be specific, the first region is displayed in the virtual scene. Alternatively, the first region is invisible in the virtual scene. To be specific, the first region is not displayed in the virtual scene.

For example, if the first region is visible in the virtual scene, and the first region is implemented as a middle region of a scene picture of a three-dimensional virtual scene currently displayed by the terminal, the interaction control is dragged to the region, the second virtual character corresponding to the second account is to be added to the three-dimensional virtual scene, and the second virtual character is to be displayed in any idle display region in the three-dimensional virtual scene.

If the first region is invisible in the three-dimensional virtual scene, the second virtual character corresponding to the second account is to be added to the first region outside the three-dimensional virtual scene currently displayed by the terminal after the interaction control is triggered, and the first region is still in the three-dimensional virtual scene.

In some embodiments, in response to a dragging operation of dragging the interaction control toward the virtual scene, the interaction control is switched to a second virtual character located in the virtual scene, and the second virtual character corresponding to the second account is added to the virtual scene (or added to the virtual scene for display). In some embodiments, a switching process of switching the interaction control to the second virtual character located in the virtual scene is visible, for example, an animation switching effect is displayed. Alternatively, the switching process of switching the interaction control to the second virtual character located in the virtual scene is invisible.

In some embodiments, the interaction control located in the first region is switched to the second virtual character located in the virtual scene, and the second virtual character corresponding to the second account is added to the virtual scene (or added to the virtual scene for display). In some embodiments, a switching process of switching the interaction control to the second virtual character located in the virtual scene is visible, for example, an animation switching effect is displayed. Alternatively, the switching process of switching the interaction control to the second virtual character located in the virtual scene is invisible.

In some embodiments, the avatar of the second account located in the first region of the virtual scene is switched and displayed as the second virtual character located in the virtual scene through an animation. For example, when the interaction control is dragged into the first region, the avatar of the second account in the interaction control displayed in the first region is switched to the second virtual character located in the virtual scene through an animation. If the avatar is a character avatar of the second virtual character, an animation in which the avatar of the second account is deployed into the second virtual character is displayed. If the avatar is not the character avatar of the second virtual character, the animation in which the avatar of the second account is switched and displayed as the second virtual character is directly displayed. The specific content of the animation in which the avatar of the second account is switched and displayed as the second virtual character is not limited in this embodiment of this disclosure.

In some embodiments, a correspondence between the second account and the second virtual character is similar to a correspondence between the first account and the first virtual character.

In some embodiments, relevant information of the first message is displayed in the virtual scene based on the second virtual character, the relevant information of the first message including but not limited to at least one of message content, a message quantity, message preview, a message transmission time, and a message receiving time.

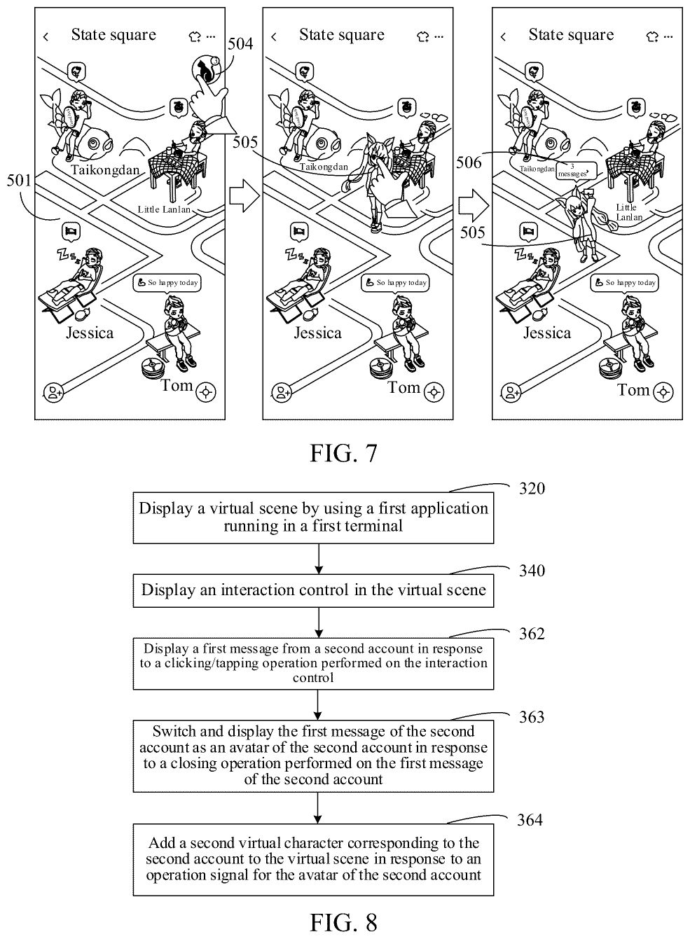

For example, as shown in FIG. 7, when the interaction control 504 is dragged toward the three-dimensional virtual scene 501, in response to the dragging action of dragging the interaction control 504 toward the three-dimensional virtual scene 501, the interaction control 504 is switched and displayed as a second virtual character 505, and message content of a first message 506 is displayed around the second virtual character 505.

In some embodiments, the virtual scene is a virtual scene provided by the first application. After the first account adds the second virtual character corresponding to the second account to the virtual scene, the first application transmits a prompt message to the second account to prompt the second account that the second virtual character corresponding to the second account has been added to the virtual scene by the first account. The second account may log in to the first application through the prompt message and perform social interaction with the first account through the virtual character in the virtual scene.

Based on the above, according to the method provided in this embodiment, the virtual scene can be implemented as a three-dimensional virtual scene, and the interaction control may be implemented as a two-dimensional interaction control, so that the two-dimensional interaction control is displayed in the three-dimensional virtual scene. Through differentiation of dimensions of the scene and the control, an operation object of the user and a scene picture are isolated, so that the user can clarify the operation object, thereby improving human-computer interaction efficiency.

According to the method provided in this embodiment, the second virtual character is added to the virtual scene through the dragging operation performed on the interaction control displayed in the virtual scene, so that the player can directly perform social interaction on the second account through the virtual character in the current virtual scene, thereby improving efficiency of social interaction between players.

According to the method provided in this embodiment, the interaction control is dragged to a visible region of the virtual scene, so that the player may directly interact with the second virtual character in the current virtual scene, thereby improving the human-computer interaction efficiency. The second virtual character corresponding to the second account is added to the invisible region of the virtual scene, thereby reducing rendering overheads of a computer.

According to the method provided in this embodiment, after the interaction control is dragged to the first region, the avatar of the second account displayed on the interaction control is switched to the second virtual character representing the second account through an animation. Since an account avatar may accurately identify an account, a process of selecting the second virtual character by the player is more accurate.

According to the method provided in this embodiment, display of the first message from the second account based on the second virtual character is supported, so that the player can directly receive the message from the second account in the virtual scene, thereby improving the human-computer interaction efficiency.

According to the method provided in this embodiment, in a case that the second account logs in to the first application and does not enter the virtual scene, the second virtual character corresponding to the second account is added to the virtual scene when the player triggers, on the interaction control, an operation performed on the second account. To be specific, the player can add the virtual character corresponding to the second account in the virtual scene in a case that the second account is online, thereby improving effectiveness of performing interaction with the second account through the virtual character.

In some possible embodiments, the foregoing operation 360 includes operation 362, operation 363, and operation 364.

FIG. 8 is a schematic flowchart of a method for interaction in a virtual scene according to an embodiment of this disclosure. In this embodiment, an example in which the method is performed by the terminal shown in FIG. 2 is used for description. The method includes at least some of the following operations:

Operation 320: Display a virtual scene by using a first application running in a first terminal. For example, the virtual scene is displayed in a first application on a first terminal. In an example, a first account corresponding to a first virtual character is logged into the first application.

A first account corresponding to a first virtual character is logged in to the first application.

In some embodiments, the virtual scene may be a two-dimensional virtual environment, may be a 2.5-dimensional virtual environment, or may be a three-dimensional virtual environment, which is not limited in this embodiment of this disclosure.

For example, as shown in FIG. 5, a three-dimensional virtual scene 501 corresponding to the first account is displayed. A first virtual character 502 is displayed in the three-dimensional virtual scene 501. The first virtual character 502 performs virtual social interaction with another virtual character 503 in the three-dimensional virtual scene 501.

Operation 340: Display an interaction control in the virtual scene. For example, an interaction control element is displayed in the virtual scene. In an example, the interaction control element indicates interaction information between the first account and a second account in an interaction scene outside the virtual scene.

For example, as shown in FIG. 6, an interaction control 504 is displayed in the three-dimensional virtual scene 501. The interaction control 504 may be a message prompt control and/or a chat control. In this embodiment, an example in which the interaction control 504 includes an avatar 5041 of a second account and a message quantity 5042 is used.

Operation 362: Display a first message from a second account in response to a clicking/tapping operation performed on the interaction control. For example, information related to the message is displayed from the second account associated with the second virtual character in the virtual scene.

In some embodiments, the first message from the second account is displayed in response to the clicking/tapping operation performed on the interaction control. Alternatively, the first message from the second account is displayed in response to a double-clicking/tapping operation performed on the interaction control. Alternatively, the first message from the second account is displayed in response to a sliding operation performed on the interaction control. In this embodiment, an example in which the first message from the second account is displayed in response to the clicking/tapping operation performed on the interaction control is used.

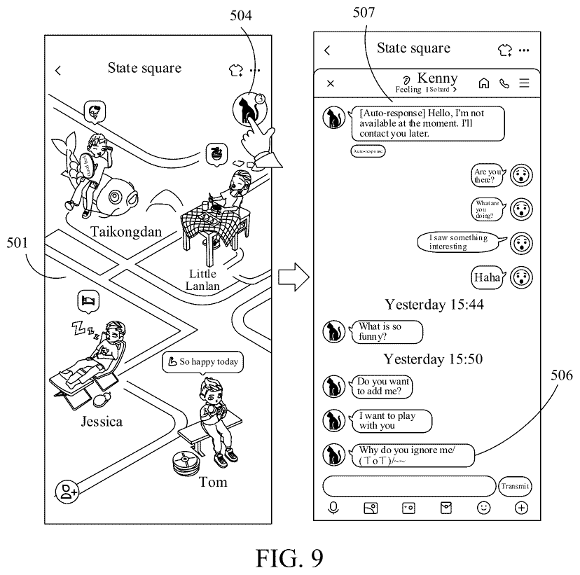

For example, as shown in FIG. 9, in response to a clicking/tapping operation performed on the interaction control 504, a chat interface 507 with the second account is displayed. A first message 506 from the second account is displayed in the chat interface 507. For example, the chat interface 507 is a floating window interface suspended on a three-dimensional virtual scene.

In some embodiments, when the chat interface 507 is implemented as the floating window interface suspended on the three-dimensional virtual scene, a transparency of a background of the floating window interface satisfies a transparency requirement. For example, the transparency of the background of the floating window interface is 70%. A transparency of a message bubble is in a range of 0% to 50%, so that a message in the message bubble is visible.

In some embodiments, the foregoing chat interface 507 may also be a split-screen interface. For example, a terminal screen includes a first display region and a second display region. A scene picture of the virtual scene is displayed in the first display region. The chat interface 507 is displayed in the second display region. For example, if a message transmitted by the second account is a video message or the second account transmits a video call invitation, the video message transmitted by the second account may be displayed in the second display region. Alternatively, a video call interface corresponding to the second account is displayed in the second display region.

Operation 363: Switch and display the first message of the second account as an avatar of the second account in response to a closing operation performed on the first message of the second account. For example, the second virtual character is added in response to detecting the chat control element is closed after the view operation is performed.

In some embodiments, a switching process of switching the first message of the second account to the avatar of the second account is visible, for example, an animation switching effect is displayed, including but not limited to at least one of closing, shrinking, fading, blurring, collapsing, and the like. Alternatively, the switching process of switching the first message of the second account to the avatar of the second account is invisible.

In some embodiments, the avatar of the second account is displayed at an edge or a corner of the virtual scene. For example, the avatar of the second account is displayed at a lower left corner of the three-dimensional virtual scene.

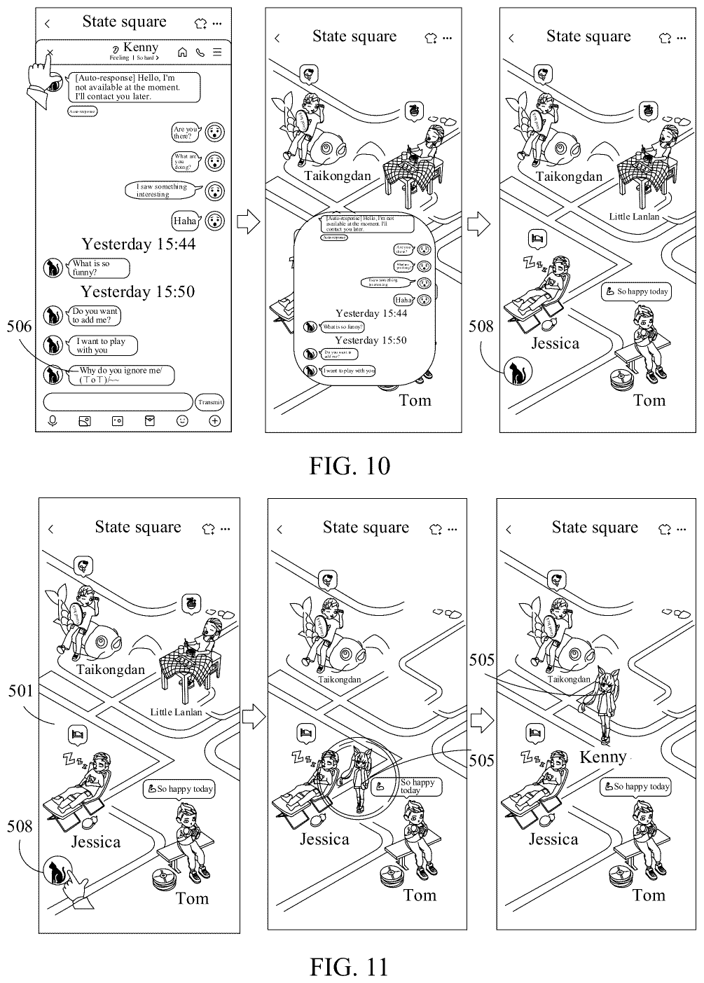

For example, as shown in FIG. 10, the first message 506 of the second account is switched and displayed as an avatar 508 of the second account through an animation in response to a closing operation performed on the first message 506 of the second account. In other words, the chat interface 507 is switched and displayed as the avatar 508 of the second account through an animation in response to a closing operation performed on the chat interface 507.

Operation 364: Add a second virtual character corresponding to the second account to the virtual scene in response to an operation signal for the avatar of the second account. For example, in response to detecting a user operation on the interaction control element, a second virtual character corresponding to the second account is added to the virtual scene.

An operation corresponding to the operation signal for the avatar of the second account includes but is not limited to at least one of clicking/tapping, double-clicking/tapping, dragging, and the like.

In some embodiments, the second virtual character corresponding to the second account is added to the virtual scene for display in response to an operation of clicking/tapping the avatar of the second account. In some embodiments, the second virtual character corresponding to the second account is added to the virtual scene for display in response to an operation of double-clicking/tapping the avatar of the second account. In some embodiments, the second virtual character corresponding to the second account is added to the virtual scene for display in response to an operation of sliding the avatar of the second account. In some embodiments, the second virtual character corresponding to the second account is added to the virtual scene for display in response to a dragging operation of dragging the avatar of the second account to any position in the virtual scene.

In some embodiments, the second virtual character corresponding to the second account is added to the virtual scene for display in response to a dragging operation of dragging the avatar of the second account into a first region of the virtual scene. In some embodiments, the first region is visible in the virtual scene. To be specific, the first region is displayed in the virtual scene. Alternatively, the first region is invisible in the virtual scene. To be specific, the first region is not displayed in the virtual scene.

In some embodiments, in response to a dragging operation of dragging the avatar of the second account toward the virtual scene, the avatar of the second account is switched to the second virtual character located in the virtual scene, and the second virtual character corresponding to the second account is added to the virtual scene for display. In some embodiments, a switching process of switching the avatar of the second account to the second virtual character located in the virtual scene is visible, for example, an animation switching effect is displayed. Alternatively, the switching process of switching the avatar of the second account to the second virtual character located in the virtual scene is invisible.

In some embodiments, the avatar of the second account located in the first region is switched to the second virtual character located in the virtual scene, and the second virtual character corresponding to the second account is added to the virtual scene for display. In some embodiments, the switching process of switching the avatar of the second account to the second virtual character located in the virtual scene is visible, for example, an animation switching effect is displayed. Alternatively, the switching process of switching the avatar of the second account to the second virtual character located in the virtual scene is invisible.

In some embodiments, a correspondence between the second account and the second virtual character is similar to a correspondence between the first account and the first virtual character. In some embodiments, relevant information of the first message is displayed in the virtual scene based on the second virtual character, the relevant information of the first message including but not limited to at least one of message content, a message quantity, message preview, a message transmission time, and a message receiving time. For example, as shown in FIG. 11, the avatar 508 of the second account is dragged toward the three-dimensional virtual scene 501. In response to the dragging operation of dragging the avatar 508 of the second account toward the three-dimensional virtual scene 501, the avatar 508 of the second account is switched and displayed as the second virtual character 505.

Based on the above, according to the method provided in this embodiment, after the first message from the second account is displayed by clicking/tapping the interaction control, the first message is to be switched and displayed as the avatar of the second account if the first message is closed. Subsequently, a player may add the second virtual character corresponding to the second account to the virtual scene for display by performing an operation on the avatar of the second account. In this embodiment, the player can timely respond to the message transmitted by the second account by triggering the interaction control. In addition, after processing a current unread message, the player can further add the second virtual character corresponding to the second account to the virtual scene for display through the operation performed on the avatar corresponding to the interaction control, so that the player directly interacts with the second account through the second virtual character in the virtual scene subsequently, thereby improving efficiency of social interaction between players.

In some possible embodiments, the foregoing operation 360 includes operation 365.

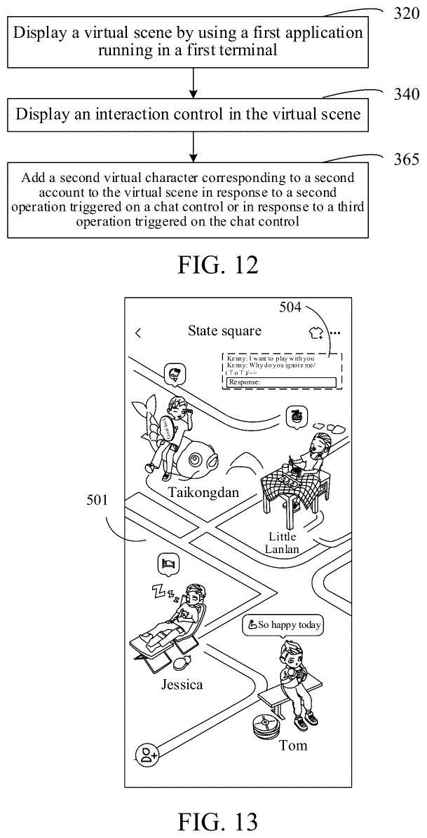

FIG. 12 is a schematic flowchart of a method for interaction in a virtual scene according to an embodiment of this disclosure. In this embodiment, an example in which the method is performed by the terminal shown in FIG. 2 is used for description. The method includes at least some of the following operations:

Operation 320: Display a virtual scene by using a first application running in a first terminal. For example, the virtual scene is displayed in a first application on a first terminal. In an example, a first account corresponding to a first virtual character is logged into the first application.

A first account corresponding to a first virtual character is logged in to the first application.

In some embodiments, the virtual scene may be a two-dimensional virtual environment, may be a 2.5-dimensional virtual environment, or may be a three-dimensional virtual environment, which is not limited in this embodiment of this disclosure.

For example, as shown in FIG. 5, a three-dimensional virtual scene 501 corresponding to the first account is displayed. A first virtual character 502 is displayed in the three-dimensional virtual scene 501. The first virtual character 502 performs virtual social interaction with another virtual character 503 in the three-dimensional virtual scene 501.

Operation 340: Display an interaction control in the virtual scene. For example, an interaction control element is displayed in the virtual scene. In an example, the interaction control element indicates interaction information between the first account and a second account in an interaction scene outside the virtual scene.

For example, as shown in FIG. 13, an interaction control 504 is displayed in the three-dimensional virtual scene 501. In this embodiment, an example in which the interaction control 504 is a chat control is used.

Operation 365: Add a second virtual character corresponding to a second account to the virtual scene in response to a second operation triggered on a chat control or in response to a third operation triggered on the chat control. For example, the second virtual character is added in response to detecting a view operation being performed on the chat control element to view a first message from the second account, or the second virtual character is added in response to detecting a send operation being performed on the chat control element to send a second message to the second account.

The second operation is configured for viewing a first message from the second account. The third operation is configured for transmitting a second message to the second account.

In some embodiments, the second virtual character corresponding to the second account is added to the virtual scene for display in response to the first account viewing the first message (i.e., the triggered second operation) from the second account on the interaction control. The interaction control is the chat control. In some embodiments, the first message is an unread message or a read message.

In some embodiments, after the first account views the first message from the second account on the interaction control (i.e., after the second operation is triggered), the second virtual character corresponding to the second account is added to the virtual scene for display in response to an operation of closing the interaction control. The interaction control is the chat control. In some embodiments, the first message is an unread message or a read message.

In some embodiments, the second virtual character corresponding to the second account is added to the virtual scene for display in response to the first account transmitting the second message (i.e., the triggered third operation) to the second account on the interaction control. The interaction control is the chat control. In some embodiments, the second message includes at least one of text, picture, and voice.

In some embodiments, after the first account transmits the second message to the second account on the interaction control (i.e., after the third operation is triggered), the second virtual character corresponding to the second account is added to the virtual scene for display in response to the operation of closing the interaction control. The interaction control is the chat control. In some embodiments, the second message includes at least one of text, picture, and voice.

In some embodiments, a correspondence between the second account and the second virtual character is similar to a correspondence between the first account and the first virtual character.

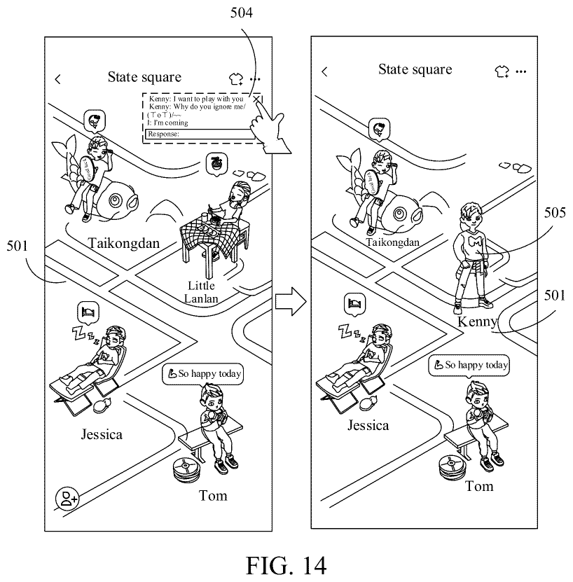

For example, as shown in FIG. 14, after the second message is transmitted to the second account on the interaction control 504 (i.e., the chat control in this embodiment), a second virtual character 505 corresponding to the second account is added to the three-dimensional virtual scene 501 for display in response to an operation of closing the interaction control 504 (i.e. the chat control in this embodiment).

Based on the above, according to the method provided in this embodiment, the second virtual character is added to the virtual scene for display through an operation of viewing the first message or transmitting the second message on the chat control displayed in the virtual scene. According to the method provided in this embodiment, a more coherent usage experience and fun are provided to a player through a simple and convenient operation, thereby enhancing interaction between players, and facilitating positive development of virtual social interaction among the players.

According to the method provided in this embodiment, after the chat control is closed, the second virtual character corresponding to the second account is added to the virtual scene for display, so that the player can timely respond to the message transmitted by the second account or transmit a message to the second account by triggering the chat control, and can further continuously interact with the second account through the second virtual character displayed in the virtual scene, thereby improving the efficiency of social interaction between players.

According to the method provided in this embodiment, if the chat control is closed, the chat control is to be switched and displayed as an avatar of the second account. Subsequently, a player may add the second virtual character corresponding to the second account to the virtual scene for display by performing an operation on the avatar of the second account. The player may choose a time to add the second virtual character corresponding to the second account to the virtual scene through the operation performed on the avatar, thereby improving flexibility of performing an operation of adding the virtual character by the player.

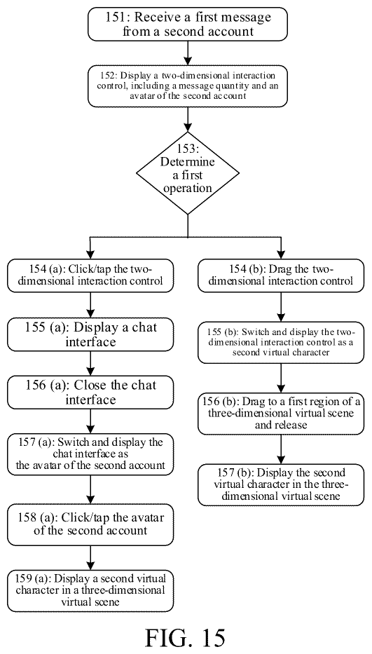

FIG. 15 is an operation flowchart of a method for interaction in a virtual scene according to an embodiment of this disclosure. An example in which the method is performed by the terminal shown in FIG. 2 is used for description. The method includes at least some of the following operations:

Operation 151: Receive a first message from a second account.

A client used by a first account has received the first message from the second account, including at least one of a transmission time, a transmission account, a receiving account, message content, and the like of the first message.

The first message of the second account may be pushed to the client used by the first account by a server or may be pushed to the client used by the first account by a client used by the second account.

Operation 152: Display a two-dimensional interaction control, including a message quantity and an avatar of the second account.

The client used by the first account displays the two-dimensional interaction control based on the received first message from the second account. Display content of the two-dimensional interaction control includes the message quantity and the avatar of the second account. The two-dimensional interaction control may be a message prompt control and/or a chat control.

In some embodiments, a display material of the two-dimensional interaction control may be transmitted by the server to the client and/or stored locally in the client. The client displays content such as the message quantity and the avatar of the second account through the display material of the two-dimensional interaction control in response to the client having received the first message from the second account.

Operation 153: Determine a first operation.

The first account may perform the first operation such as a clicking/tapping operation, a dragging operation, a double-clicking/tapping operation, and a sliding operation on the two-dimensional interaction control. The client determines the first operation performed by the first account on the displayed message quantity and the avatar of the second account.

For example, the client determines the first operation performed by the first account through a touch screen, or the client determines the first operation performed by the first account through an event triggered by a mouse.

Operation 154 (a): Click/tap the two-dimensional interaction control.

If the client determines that the first operation performed by the first account is clicking/tapping the two-dimensional interaction control, the client performs operation 155 (a) after operation 154 (a).

Operation 155 (a): Display a chat interface.

Display content of the chat interface may be pushed to the client by the server, and/or the display content of the chat interface is stored locally in the client.

In response to the first operation of clicking/tapping the two-dimensional interaction control by the first account, the client displays the chat interface based on the received display content of the chat interface and/or the display content of the chat interface stored locally. For example, if the client displays the chat interface of the first account and the second account, operation 156 (a) may be performed.

Operation 156 (a): Close the chat interface.

The first account may perform an operation on the chat interface, for example, inputting a text, inputting a voice, and closing an interface. The client may determine or identify the operation performed by the first account on the chat interface. For example, the operation performed by the first account on the chat interface is determined through the touch screen, or the operation performed by the first account on the chat interface is determined through the event triggered by the mouse.

If the first account closes the chat interface, operation 157 (a) is performed.

Operation 157 (a): Switch and display the chat interface as the avatar of the second account.

The avatar of the second account is pushed to the client by the server, or the avatar of the second account is stored locally in the client.

The client switches and displays the chat interface as the avatar of the second account in response to the operation of closing the chat interface by the first account.

In some embodiments, a switching process of switching and displaying the chat interface as the avatar of the second account is visible. For example, an animation switching effect is displayed. Alternatively, the switching process of switching and displaying the chat interface as the avatar of the second account is invisible.

For example, the client collapses the chat interface and switches to the avatar of the second account. The avatar of the second account is displayed at a lower left corner of a three-dimensional virtual scene.

Operation 158 (a): Click/tap the avatar of the second account.

The first account may perform an operation on the avatar of the second account displayed on the client, for example, clicking/tapping, double clicking/tapping, sliding, and dragging. The client may determine or identify the operation performed by the first account on the chat interface.

If the client determines the operation of clicking/taping the avatar of the second account by the first account, the client performs operation 159 (a).

Operation 159 (a): Display a second virtual character in a three-dimensional virtual scene.

A display material of the second virtual character may include a character display material, a skin display material, and the like. For example, the character display material includes at least one of a height, a figure, a gender, and the like of a character. The skin display material includes at least one of a hairstyle, a skin color, a top, a bottom, a dress, shoes/boots, a makeup, and the like.

In some embodiments, the display material of the second virtual character is pushed to the client by the server, and/or the display material of the second virtual character is stored locally in the client. For example, the server pushes the display material of the second virtual character to the client, and the client displays the second virtual character in the three-dimensional virtual scene. Alternatively, the client locally stores the display material of the second virtual character. The server pushes a material identifier to the client. The client generates the second virtual character through rendering based on the material identifier and displays the second virtual character in the three-dimensional virtual scene.

In response to the operation of clicking/tapping the avatar of the second account by the first account, the client adds the second virtual character to the three-dimensional virtual scene for display. The second virtual character corresponds to the second account.

Operation 154 (b): Drag the two-dimensional interaction control.

If the client determines that the first operation performed by the first account is dragging the two-dimensional interaction control, the client performs operation 155 (b) after operation 154 (b).

Operation 155 (b): Switch and display the two-dimensional interaction control as the second virtual character.

In some embodiments, when the client determines that a two-dimensional interaction control on a HUD layer enters a first region or moves, the two-dimensional interaction control is not displayed, which may also be understood as that the two-dimensional interaction control disappears. Then the client displays the second virtual character in the three-dimensional virtual scene. A position at which the second virtual character is displayed in the three-dimensional virtual scene may be an intersection of a ray emitted from a picture generated by a camera model and a plane (for example, a ground plane) in the three-dimensional virtual scene, or a position in the three-dimensional virtual scene mapped by a position at which the two-dimensional interaction control disappears on the HUD layer.

The client switches and displays the two-dimensional interaction control as the second virtual character in response to the operation of dragging the two-dimensional interaction control by the first account.

In some embodiments, a switching process of switching and displaying the two-dimensional interaction control as the second virtual character is visible. For example, an animation switching effect is displayed. Alternatively, the switching process of switching and displaying the two-dimensional interaction control as the second virtual character is invisible.

Operation 156 (b): Drag to a first region of the three-dimensional virtual scene and release.

The first account may perform a dragging operation on the second virtual character displayed on the client, for example, dragging the second virtual character to the first region of the three-dimensional virtual scene and releasing.

In some embodiments, the first region is visible or invisible.

The client may identify or determine whether the first account has released, a releasing position, and the like. For example, the client determines through a touch screen that the first account has released in the first region, or the client determines through an event triggered by a mouse that the first account has released in the first region.

If the first account drags the two-dimensional interaction control into the first region in the three-dimensional virtual scene and releases, the client performs operation 157 (b).

Operation 157 (b): Display a second virtual character in a three-dimensional virtual scene.

A display material of the second virtual character may include a character display material, a skin display material, and the like. For example, the character display material includes at least one of a height, a figure, a gender, and the like of a character. The skin display material includes at least one of a hairstyle, a skin color, a top, a bottom, a dress, shoes/boots, a makeup, and the like.

In some embodiments, the display material of the second virtual character is pushed to the client by the server, and/or the display material of the second virtual character is stored locally in the client. For example, the server pushes the display material of the second virtual character to the client, and the client displays the second virtual character in the three-dimensional virtual scene. Alternatively, the client locally stores the display material of the second virtual character. The server pushes a material identifier to the client. The client generates the second virtual character through rendering based on the material identifier and displays the second virtual character in the three-dimensional virtual scene.

In response to the operation of dragging the two-dimensional interaction control to the first region in the three-dimensional virtual scene and releasing by the first account, the client adds the second virtual character to the three-dimensional virtual scene for display. The second virtual character corresponds to the second account.

Based on the above, according to the method provided in this embodiment, in a case that the first message of the second account is received, through determination of the operation performed by the first account, the first account is supported in using a coherent, simple, and convenient operation process to add the second virtual character to the virtual scene for display, thereby providing the player with a more coherent usage experience and fun, enhancing interaction between players, and facilitating positive development of virtual social interaction among the players.

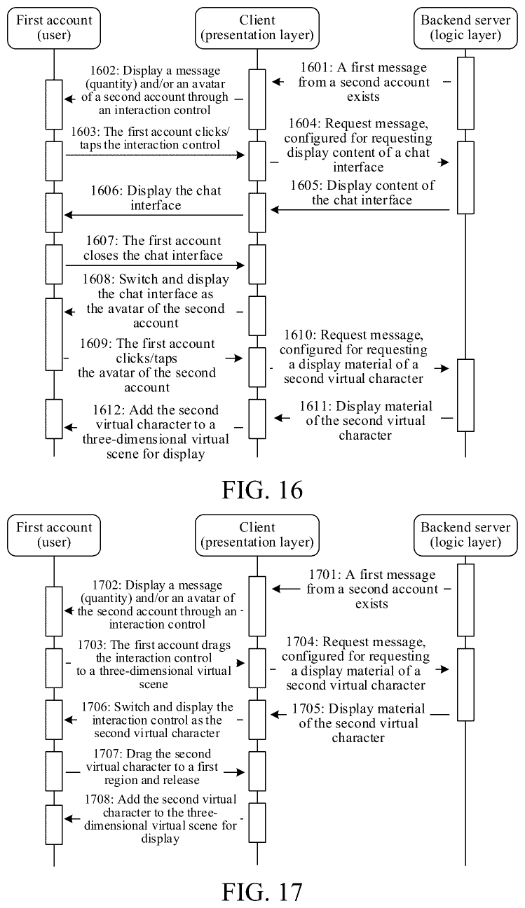

FIG. 16 is a timing diagram according to an embodiment of this disclosure. An example in which the timing diagram is a timing diagram between the terminal and/or the server shown in FIG. 2 is used for description, including at least some of the following operations:

Operation 1601: A backend server (a logic layer) transmits a prompt to a client (a presentation layer) to prompt that there is a first message from a second account.

The backend server (the logic layer) has received the first message from the second account, including at least one of a transmission time, a transmission account, a receiving account, message content, and the like of the first message. In response to the first message having been received from the second account, the backend server (the logic layer) transmits the prompt to the client (the presentation layer), prompt content including at least one of the transmission time, the transmission account, the receiving account, the message content, and the like of the first message.

Operation 1602: The client (the presentation layer) displays a message (quantity) and/or an avatar of the second account to a first account through an interaction control.

A display material of the interaction control may be transmitted by the backend server (the logic layer) to the client and/or stored locally in the client.

In some embodiments, the client displays content such as the message quantity and the avatar of the second account through the display material of the interaction control in response to the client having received the first message from the second account.

Operation 1603: The first account clicks/taps the interaction control.

The first account may perform the first operation such as a clicking/tapping operation, a dragging operation, a double-clicking/tapping operation, and a sliding operation on the interaction control. The client determines the first operation performed by the first account on the interaction control.

Operation 1604: The client (the presentation layer) transmits a request message to the backend server (the logic layer) to request display content of a chat interface.

The request message is a first request message and is configured for requesting the display content of the chat interface, for example, at least one of historical chat details, the avatar of the second account, and a transmission time of a historical message.

In some embodiments, the display content of the chat interface may also be stored locally in the client. The client (the presentation layer) transmits the request message to the backend server (the logic layer) to request an identifier of the display content of the chat interface, to generate the display content of the chat interface.

The chat interface may be a chat interface between the first account and the second account or may be a chat interface among the first account, the second account, and another account.

In response to the first operation performed by the first account on the interaction control, for example, an operation of clicking/tapping the interaction control, the client (the presentation layer) transmits the first request message to the backend server (the logic layer).

Operation 1605: The backend server (the logic layer) transmits the display content of the chat interface to the client (the presentation layer).

The display content of the chat interface includes at least one of historical chat details, the avatar of the second account, a transmission time of a historical message, and the like.

In response to the client (the presentation layer) transmitting the request message to the backend server (the logic layer), the backend server (the logic layer) transmits the display content of the chat interface to the client (the presentation layer).

Operation 1606: The client (the presentation layer) displays the chat interface to the first account.

In response to the display content of the chat interface received by the client (the presentation layer) and/or the display content of the chat interface stored locally in the client, the client (the presentation layer) generates and displays the chat interface.

Operation 1607: The first account closes the chat interface.

The first account may perform an operation on the chat interface, for example, inputting a text, inputting a voice, and closing an interface. The client may determine or identify the operation performed by the first account on the chat interface. For example, the operation performed by the first account on the chat interface is determined through the touch screen, or the operation performed by the first account on the chat interface is determined through the event triggered by the mouse.

Operation 1608: The client (the presentation layer) switches and displays the chat interface as the avatar of the second account.

The avatar of the second account is pushed to the client by the server, or the avatar of the second account is stored locally in the client.

The client (the presentation layer) switches and displays the chat interface as the avatar of the second account in response to the operation of closing the chat interface by the first account.

In some embodiments, a switching process of switching and displaying the chat interface as the avatar of the second account is visible. For example, an animation switching effect is displayed. Alternatively, the switching process of switching and displaying the chat interface as the avatar of the second account is invisible.

Operation 1609: The first account clicks/taps the avatar of the second account.

The first account may perform an operation on the avatar of the second account displayed on the client, for example, clicking/tapping, double clicking/tapping, sliding, and dragging. The client may determine or identify the operation performed by the first account on the chat interface.

Operation 1610: The client (the presentation layer) transmits a request message to the backend server (the logic layer) to request a display material of a second virtual character.

The request message is a second request message, is configured for requesting the display material of the second virtual character, for example, a character display material and a skin display material, and may include at least one of a height, a figure, a gender, a hairstyle, a skin color, a top, a bottom, a dress, shoes/boots, a makeup, and the like of a character.

The client (the presentation layer) transmits the second request message to the backend server (the logic layer) in response to an operation performed by the first account on the avatar of the second account, for example, clicking/tapping the avatar of the second account.

Operation 1611: The backend server (the logic layer) transmits the display material of the second virtual character to the client (the presentation layer).

In response to the client (the presentation layer) transmitting the request message to the backend server (the logic layer), the backend server (the logic layer) transmits the display material of the second virtual character to the client (the presentation layer).

Operation 1612: The client (the presentation layer) adds the second virtual character to a three-dimensional virtual scene and displays the second virtual character to the first account.

In some embodiments, the display material of the second virtual character is pushed to the client by the server, and/or the display material of the second virtual character is stored locally in the client. For example, the server pushes the display material of the second virtual character to the client, and the client displays the second virtual character in the three-dimensional virtual scene. Alternatively, the client locally stores the display material of the second virtual character. The server pushes a material identifier to the client. The client generates the second virtual character through rendering based on the material identifier and displays the second virtual character in the three-dimensional virtual scene.

Based on the above, according to the method provided in this embodiment, the display method of the virtual character is jointly performed by the first account, the client (the presentation layer), and the backend server (the logic layer), so as to support adding the second virtual character to the virtual scene for display after the first account operates the interaction control. The coherent, simple, and convenient operation process provides a player with a more coherent usage experience and fun, enhances interaction between players, and facilitates positive development of virtual social interaction among the players.

FIG. 17 is a timing diagram according to an embodiment of this disclosure. An example in which the timing diagram is a timing diagram between the terminal and the server shown in FIG. 2 is used for description, including at least some of the following operations:

Operation 1701: A backend server (a logic layer) transmits a prompt to a client (a presentation layer) to prompt that there is a first message from a second account.

The backend server (the logic layer) has received the first message from the second account, including at least one of a transmission time, a transmission account, a receiving account, message content, and the like of the first message. In response to the first message having been received from the second account, the backend server (the logic layer) transmits the prompt to the client (the presentation layer), prompt content including at least one of the transmission time, the transmission account, the receiving account, the message content, and the like of the first message.

Operation 1702: The client (the presentation layer) displays a message (quantity) and/or an avatar of the second account to a first account through an interaction control.

A display material of the interaction control may be transmitted by the backend server (the logic layer) to the client and/or stored locally in the client.

In some embodiments, the client displays content such as the message quantity and the avatar of the second account through the display material of the interaction control in response to the client having received the first message from the second account.

Operation 1703: The first account drags the interaction control to a three-dimensional virtual scene.

The first account may perform the first operation such as a clicking/tapping operation, a dragging operation, a double-clicking/tapping operation, and a sliding operation on the interaction control. The client determines the first operation performed by the first account on the interaction control.

Operation 1704: The client (the presentation layer) transmits a request message to the backend server (the logic layer) to request a display material of a second virtual character.

The request message is a second request message, is configured for requesting the display material of the second virtual character, for example, a character display material and a skin display material, and may include at least one of a height, a figure, a gender, a hairstyle, a skin color, a top, a bottom, a dress, shoes/boots, a makeup, and the like of a character.

The client (the presentation layer) transmits the request message to the backend server (the logic layer) in response to the operation of dragging the interaction control to the three-dimensional virtual scene by the first account.

Operation 1705: The backend server (the logic layer) transmits the display material of the second virtual character to the client (the presentation layer).

In response to the client (the presentation layer) transmitting the request message to the backend server (the logic layer), the backend server (the logic layer) transmits the display material of the second virtual character to the client (the presentation layer).

Operation 1706: The client (the presentation layer) switches and displays the interaction control as the second virtual character.

In some embodiments, when the client determines that an interaction control on a HUD layer enters a first region or moves, the interaction control is not displayed, which may also be understood as that the interaction control disappears. Then the client displays the second virtual character in the three-dimensional virtual scene. A position at which the second virtual character is displayed in the three-dimensional virtual scene may be an intersection of a ray emitted from a picture generated by a camera model and a plane (for example, a ground plane) in the three-dimensional virtual scene, or a position in the three-dimensional virtual scene mapped by a position at which the interaction control disappears on the HUD layer.

In some embodiments, a switching process of switching and displaying the interaction control as the second virtual character is visible. For example, an animation switching effect is displayed. Alternatively, the switching process of switching and displaying the interaction control as the second virtual character is invisible.

Operation 1707: The first account drags the second virtual character into a first region and releases.

The client may identify or determine whether the first account has released, a releasing position, and the like. For example, the client determines through a touch screen that the first account has released in the first region, or the client determines through an event triggered by a mouse that the first account has released in the first region.

Operation 1708: The client (the presentation layer) adds the second virtual character to a three-dimensional virtual scene and displays the second virtual character to the first account.

In some embodiments, the display material of the second virtual character is pushed to the client by the server, and/or the display material of the second virtual character is stored locally in the client. For example, the server pushes the display material of the second virtual character to the client, and the client displays the second virtual character in the three-dimensional virtual scene. Alternatively, the client locally stores the display material of the second virtual character. The server pushes a material identifier to the client. The client generates the second virtual character through rendering based on the material identifier and displays the second virtual character in the three-dimensional virtual scene.

Based on the above, according to the method provided in this embodiment, the display method of the virtual character is jointly performed by the first account (a user), the client (the presentation layer), and the backend server (the logic layer), so as to support adding the second virtual character to the virtual scene for display after the first account operates the interaction control. The coherent, simple, and convenient operation process provides a player with a more coherent usage experience and fun, enhances interaction between players, and facilitates positive development of virtual social interaction among the players.

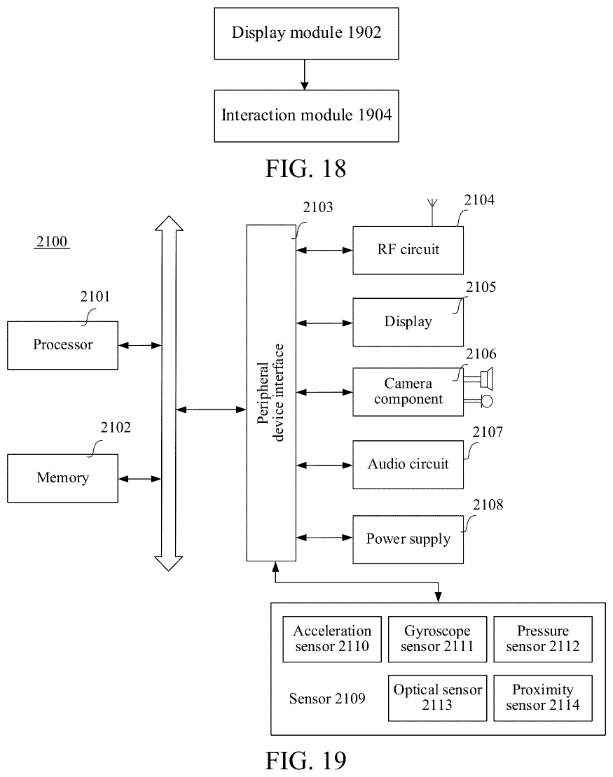

FIG. 18 is a schematic structural diagram of an apparatus for interaction in a virtual scene according to an embodiment of this disclosure. The apparatus includes at least part of a display module 1902 and an interaction module 1904.

Display module 1902: The display module is configured to display a virtual scene, the virtual scene being a scene running in a first application of a first terminal, a first account corresponding to a first virtual character being logged in to the first application, and the virtual scene being configured for the first virtual character to interact with another virtual character.

The display module 1902 is further configured to display an interaction control in the virtual scene, the interaction control being configured for the first account to interact with a second account in an interaction scene outside the virtual scene.

Interaction module 1904: The interaction module is configured to respond to an operation signal triggered on the interaction control.

The display module 1902 is further configured to add a second virtual character corresponding to the second account to the virtual scene.

In an example design, the virtual scene includes a three-dimensional virtual scene, and the interaction control includes a two-dimensional interaction control.

In an example design, the interaction module 1904 is further configured to respond to a dragging operation of dragging the interaction control toward the virtual scene, and the display module 1902 is further configured to add the second virtual character corresponding to the second account to the virtual scene.

In an example design, the interaction module 1904 is further configured to respond to a dragging operation of dragging the interaction control into a first region of the virtual scene, and the display module 1902 is further configured to add the second virtual character corresponding to the second account to the virtual scene, the first region being visible or invisible in the virtual scene.

In an example design, an avatar of the second account is displayed on the interaction control. The display module 1902 is further configured to switch and display the avatar of the second account located in the first region of the virtual scene as a second virtual character located in the virtual scene through an animation, the second virtual character corresponding to the second account.

In an example design, the interaction control includes a message prompt control, the message prompt control being configured to prompt existence of a first message from the second account. The display module 1902 is further configured to display relevant information of the first message in the virtual scene based on the second virtual character, the relevant information including at least one of message content, a message quantity, and message preview.

In an example design, the interaction control includes a chat control. The interaction module 1904 is further configured to respond to a second operation triggered on the chat control, and the display module 1902 is further configured to add the second virtual character corresponding to the second account to the virtual scene, the second operation being configured for viewing the first message from the second account. Alternatively, the interaction module 1904 is further configured to respond to a third operation triggered on the chat control, and the display module 1902 is further configured to add the second virtual character corresponding to the second account to the virtual scene, the third operation being configured for transmitting a second message to the second account.

In an example design, after the second operation is triggered, the interaction module 1904 is further configured to respond to an operation of closing the chat control, and the display module 1902 is further configured to add the second virtual character corresponding to the second account to the virtual scene. Alternatively, after the third operation is triggered, the interaction module 1904 is further configured to respond to the operation of closing the chat control, and the display module 1902 is further configured to add the second virtual character corresponding to the second account to the virtual scene.

In an example design, the interaction module 1904 is further configured to respond to the operation of closing the chat control, and the display module 1902 is further configured to switch and display the chat control as the avatar of the second account through an animation. The interaction module 1904 is further configured to respond to an operation signal for the avatar of the second account, and the display module 1902 is further configured to add the second virtual character corresponding to the second account to the virtual scene.

In an example design, the virtual scene is a virtual scene provided by the first application. The interaction module 1904 is configured to add the second virtual character corresponding to the second account to the virtual scene in response to the operation signal triggered on the interaction control in a case that the second account logs in to the first application and does not enter the virtual scene.

In an example design, the interaction control is configured to prompt interaction information of the second account and a plurality of second accounts in the interaction scene outside the virtual scene. The interaction module 1904 is configured to: simultaneously add second virtual characters respectively corresponding to the plurality of second accounts to the virtual scene; or successively add the second virtual characters respectively corresponding to the plurality of second accounts to the virtual scene.

In an example design, the interaction module 1904 is further configured to: add the second virtual character corresponding to the second account to the virtual scene and display an interaction animation corresponding to the second virtual character; and display a chat interface corresponding to the first account and the second account in response to a fourth operation triggered on the interaction animation.

In an example design, the interaction module 1904 is further configured to: receive a movement control operation performed on the first virtual character, the movement control operation being configured for controlling the first virtual character to move in the virtual scene; and display the chat interface corresponding to the first account and the second account when a distance between the first virtual character and the second virtual character is less than or equal to a preset distance.

In an example design, the interaction module 1904 is further configured to: receive a message transmission operation performed on a chat message on the chat interface and transmit the chat message to the second account.

In an example design, the apparatus further includes a customizing module, configured to design a virtual character, select a virtual character, customize a virtual character, create a virtual character, create a user-defined virtual character, upload a virtual character to a server, or upload a virtual character to a terminal.

FIG. 19 is a structural block diagram of a terminal 2100 according to an embodiment of this disclosure. The terminal 2100 may be at least one of a smartphone, a tablet computer, an e-book reader, a laptop computer, a desktop computer, a television, an AR terminal, a VR terminal, and an MR terminal. The terminal 2100 may also be referred to as another name such as user equipment, a portable terminal, a laptop terminal, or a desktop terminal.

The terminal 2100 usually includes a processor 2101 and a memory 2102.

The processor 2101 may include one or more processing cores, such as a 4-core processor and an 8-core processor. The processor 2101 may be implemented in at least one hardware form of a digital signal processor (DSP), a field-programmable gate array (FPGA), and a programmable logic array (PLA). The processor 2101 may also include a main processor and a coprocessor. The main processor is a processor configured to process data in an awake state and is also referred to as a central processing unit (CPU). The coprocessor is a low-power processor configured to process data in a standby state. In some embodiments, the processor 2101 may be integrated with a graphics processing unit (GPU). The GPU is configured to render and draw content that needs to be displayed on a display screen. In some embodiments, the processor 2101 may further include an augmented reality (AR) processor. The AR processor is configured to process computing operations related to augmented reality. In some embodiments, the processor 2101 may further include an artificial intelligence (AI) processor. The AI processor is configured to process computing operations related to machine learning.

The memory 2102 may include one or more computer-readable storage media. The computer-readable storage medium may be non-transient. The memory 2102 may further include a high-speed random access memory (RAM) and a nonvolatile memory, for example, one or more disk storage devices or flash storage devices. In some embodiments, the non-transitory computer-readable storage medium in the memory 2102 is configured to store at least one instruction. The at least one instruction is configured for being executed by the processor 2101 to implement the method for interaction in a virtual scene provided in the method embodiment of this disclosure.

In some embodiments, the terminal 2100 further includes a peripheral device interface 2103 and at least one peripheral device. The processor 2101, the memory 2102, and the peripheral device interface 2103 may be connected through a bus or a signal line. Each peripheral device may be connected to the peripheral device interface 2103 through a bus, a signal line, or a circuit board. Specifically, the peripheral device may include at least one of a radio frequency (RF) circuit 2104, a display screen 2105, a camera component 2106, an audio circuit 2107, and a power supply 2108.

The peripheral device interface 2103 may be configured to connect the at least one peripheral device related to input/output (I/O) to the processor 2101 and the memory 2102. In some embodiments, the processor 2101, the memory 2102, and the peripheral device interface 2103 are integrated on the same chip or circuit board. In some other embodiments, any or both of the processor 2101, the memory 2102, and the peripheral device interface 2103 may be implemented on an independent chip or circuit board, which is not limited in this embodiment.

The RF circuit 2104 is configured to receive and transmit an RF signal, which is also referred to as an electromagnetic signal. The RF circuit 2104 communicates with a communication network and other communication devices through the electromagnetic signal. The RF circuit 2104 converts an electric signal into an electromagnetic signal for transmission or converts a received electromagnetic signal into an electric signal. In some embodiments, the RF circuit 2104 includes: an antenna system, an RF transceiver, one or more amplifiers, a tuner, an oscillator, a digital signal processor, a codec chip set, a subscriber identity module card, and the like. The RF circuit 2104 may communicate with other terminals by using at least one wireless communication protocol. The wireless communication protocol includes but is not limited to: the World Wide Web, a metropolitan area network, Intranet, various generations of mobile communication networks (2G, 3G, 4G, and 5G), a wireless local area network, and/or a Wi-Fi network. In some embodiments, the RF circuit 2104 may further include a near field communication (NFC)-related circuit, which is not limited in this disclosure.

The display screen 2105 is configured to display a UI. The UI may include a graph, texts, an icon, a video, and any combination thereof. When the display screen 2105 is a touch display screen, the display screen 2105 further has the capability of collecting a touch signal on or above a surface of the display screen 2105. The touch signal may be inputted to the processor 2101 as a control signal for processing. In this case, the display screen 2105 may be further configured to provide a virtual button and/or a virtual keyboard, which are/is also referred to as a soft button and/or a soft keyboard. In some embodiments, one display screen 2105 may be arranged on a front panel of the terminal 2100. In some other embodiments, at least two display screens 2105 may be respectively arranged on different surfaces of the terminal 2100 or may be folded. In still other embodiments, the display screen 2105 may be a flexible display screen arranged on a curved surface or a folding surface of the terminal 2100. The display screen 2105 may be even arranged as a non-rectangular irregular figure, namely, a special-shaped screen. The display screen 2105 may be manufactured by using a liquid crystal display (LCD), an organic light-emitting diode (OLED), or the like.

The camera component 2106 is configured to collect an image or a video. In some embodiments, the camera component 2106 includes a front camera and a rear camera. The front camera is arranged on the front panel of the terminal, and the rear camera is arranged on the back of the terminal. In some embodiments, at least two rear cameras are arranged, which are respectively any of a main camera, a depth-of-field camera, a wide-angle camera, and a telephoto camera, to achieve background blurring through fusion of the main camera and the depth-of-field camera, panoramic photographing and VR photographing through fusion of the main camera and the wide-angle camera, or another fusion photographing function. In some embodiments, the camera component 2106 may further include a flashlight. The flashlight may be a single-color-temperature flashlight or a dual-color-temperature flashlight. The dual-color-temperature flashlight is a combination of a warm flashlight and a cold flashlight, which may be used for light compensation at different color temperatures.

The audio circuit 2107 may include a microphone and a speaker. The microphone is configured to collect sound waves of a user and an environment and convert the sound waves into electrical signals and input the electrical signals to the processor 2101 for processing, or input the electrical signals to the RF circuit 2104 to implement voice communication. For the purpose of stereo collection or noise reduction, a plurality of microphones may be respectively arranged at different parts of the terminal 2100. The microphone may be further an array microphone or an omnidirectional acquisition microphone. The speaker is configured to convert the electrical signals from the processor 2101 or the RF circuit 2104 into sound waves. The speaker may be a conventional film speaker or may be a piezoelectric ceramic speaker. When the speaker is the piezoelectric ceramic speaker, the speaker not only may convert the electric signal into the sound wave audible to a human being, but also may convert the electric signal into the sound wave inaudible to a human being, for a purpose such as ranging. In some embodiments, the audio circuit 2107 may further include a headphone jack.

The power supply 2108 is configured to supply power to components in the terminal 2100. The power supply 2108 may be an alternating current battery, a direct current battery, a disposable battery, or a rechargeable battery. When the power supply 2108 includes a rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some embodiments, the terminal 2100 further includes one or more sensors 2109. The one or more sensors 2109 include but are not limited to: an acceleration sensor 2110, a gyroscope sensor 2111, a pressure sensor 2112, an optical sensor 2113, and a proximity sensor 2114.

The memory further includes one or more programs. The one or more programs are stored in the memory. The one or more programs include a program for performing the method for interaction in a virtual scene provided in the embodiments of this disclosure.

A person skilled in the art may understand that the structure shown in FIG. 19 does not constitute a limitation on the terminal 2100. The terminal may include more or fewer components than those shown in the figure, or some merged components, or different component arrangements.

In an embodiment, a terminal is further provided, including a processor and a memory, the memory having at least one instruction, at least one program, a code set, or an instruction set stored therein. The at least one instruction, the at least one program, the code set, or the instruction set is configured to be executed by the processor to implement the foregoing method for interaction in a virtual scene.

In an embodiment, a computer-readable storage medium, such as a non-transitory computer-readable storage medium, is further provided, having at least one instruction, at least one program, a code set, or an instruction set stored therein, the at least one instruction, the at least one program, the code set, or the instruction set, when executed by a processor, implementing the foregoing method for interaction in a virtual scene. In some embodiments, the foregoing computer-readable storage medium may be a read-only memory (ROM), a RAM, a compact disc read-only memory (CD-ROM), a magnetic tape, a floppy disk, an optical data storage device, and the like.

In an embodiment, a computer program product is further provided. The computer program product has a computer program stored therein, the computer program being loaded and executed by a processor to implement the method for interaction in a virtual scene as described above.

What is claimed is:

1. A method for displaying virtual characters in a virtual scene, comprising:
displaying the virtual scene in a first application on a first terminal, wherein a first account corresponding to a first virtual character is logged into the first application;
displaying an interaction control element in the virtual scene, wherein the interaction control element indicates interaction information between the first account and a second account in an interaction scene outside the virtual scene; and
in response to detecting a user operation on the interaction control element, adding a second virtual character corresponding to the second account to the virtual scene.

2. The method according to claim 1, wherein the virtual scene is a three-dimensional virtual scene, and the interaction control element is a two-dimensional control element.

3. The method according to claim 1, wherein
the user operation is a dragging operation; and
the adding the second virtual character includes adding the second virtual character to the virtual scene in response to detecting the drag operation being performed on the interaction control element toward the virtual scene.

4. The method according to claim 3, wherein the adding the second virtual character comprises:
adding the second virtual character to the virtual scene in response to detecting the interaction control element is dragged to a designated region of the virtual scene, wherein the designated region is either visible or invisible in the virtual scene.

5. The method according to claim 1, wherein the interaction control element includes an avatar of the second account; and
the adding the second virtual character includes animating a transition from the avatar in a designated region to the second virtual character in the virtual scene.

6. The method according claim 1, wherein
the interaction control element includes a message notification control element indicating existence of a message from the second account; and,
the method further includes displaying information related to the message, from the second account associated with the second virtual character, in the virtual scene, wherein the information includes at least one of message content, message count, and message preview.

7. The method according to claim 1, wherein
the interaction control element comprises a chat control element; and
the adding the second virtual character comprises:
adding the second virtual character in response to detecting a view operation being performed on the chat control element to view a first message from the second account; or
adding the second virtual character in response to detecting a send operation being performed on the chat control element to send a second message to the second account.

8. The method according to claim 7, wherein
the adding the second virtual character, in response to the view operation being performed, includes adding the second virtual character in response to detecting the chat control element is closed after the view operation is performed; and
the adding the second virtual character, in response to the send operation being performed, includes adding the second virtual character in response to detecting the chat control element is closed after the send operation is performed.

9. The method according to claim 8, wherein the adding the second virtual character in response to detecting the chat control element is closed comprises:
animating a transition from the chat control element to an avatar of the second account; and
adding the second virtual character in response to detecting a user selection of the avatar.

10. The method according to claim 1, wherein the adding the second virtual character comprises:
adding the second virtual character in response to detecting the user operation being performed on the interaction control element when the second account is logged into the first application and is not included in the virtual scene.

11. The method according to claim 1, wherein the interaction control element indicates first interaction information for a plurality of second accounts; and
the adding the second virtual character comprises:
simultaneously adding a plurality of second virtual characters respectively corresponding to the plurality of second accounts to the virtual scene; or
successively adding the plurality of second virtual characters respectively corresponding to the plurality of second accounts to the virtual scene.

12. The method according to claim 1, further comprising:
displaying an interaction animation corresponding to the second virtual character; and
displaying a chat interface for the first account and the second account in response to detecting an interaction operation being performed on the interaction animation.

13. The method according to claim 1, further comprising:
detecting a movement control operation is performed on the first virtual character; and
displaying a chat interface corresponding to the first account and the second account when a distance between the first virtual character and the second virtual character in the virtual scene is less than or equal to a preset distance threshold.

14. The method according to claim 12, further comprising:
detecting a message send operation is performed in the chat interface; and
transmitting a chat message to the second account in response to the message send operation.

15. An apparatus, comprising:
processing circuitry configured to:
display a virtual scene in a first application on a first terminal, wherein a first account corresponding to a first virtual character is logged into the first application;
display an interaction control element in the virtual scene, wherein the interaction control element indicates interaction information between the first account and a second account in an interaction scene outside the virtual scene; and
in response to detection of a user operation on the interaction control element, add a second virtual character corresponding to the second account to the virtual scene.

16. The apparatus according to claim 15, wherein the virtual scene is a three-dimensional virtual scene, and the interaction control element is a two-dimensional control element.

17. The apparatus according to claim 15, wherein
the user operation is a dragging operation; and
the processing circuitry is configured to add the second virtual character to the virtual scene in response to detection of the drag operation being performed on the interaction control element toward the virtual scene.

18. The apparatus according to claim 17, wherein the processing circuitry is configured to:
add the second virtual character to the virtual scene in response to detection of the interaction control element being dragged to a designated region of the virtual scene, wherein the designated region is either visible or invisible in the virtual scene.

19. The apparatus according to claim 15, wherein the interaction control element includes an avatar of the second account; and
when the second virtual character is to be added to the virtual scene, the processing circuitry is configured to animate a transition from the avatar in a designated region to the second virtual character in the virtual scene.

20. A non-transitory computer-readable storage medium, storing instructions which when executed by a processor cause the processor to perform:
displaying a virtual scene in a first application on a first terminal, wherein a first account corresponding to a first virtual character is logged into the first application;
displaying an interaction control element in the virtual scene, wherein the interaction control element indicates interaction information between the first account and a second account in an interaction scene outside the virtual scene; and
in response to detecting a user operation on the interaction control element, adding a second virtual character corresponding to the second account to the virtual scene.
